(19) United States
(12) Patent Application Publication
(10) Pub. No.: US 2008/0240543 A1
(43) Pub. Date: Oct. 2, 2008

(54) Calibration and normalization method for biosensors

(76) Inventors: Wolfgang Ernst Gustav Budach, Schliengen-Mauchen (DE); Dieter Neuschafer, Muttenz (DE); Stephen C. Schulz, Lee, NH (US); Brian T. Cunningham, Champaign, IL (US); Lance G. Laing, Belmont, MA (US); Peter Y. Li, Andover, MA (US); Brant Binder, Chestnut Hill, MA (US); Gangadhar Jogikalmath, Cambridge, MA (US); Alex Borsody, Lowell, MA (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 12/077,809

(22) Filed: Mar. 20, 2008

Related U.S. Application Data
(60) Provisional application No. 60/921,001, filed on Mar. 30, 2007.
(60) Provisional application No. 60/998,880, filed on Oct. 11, 2007.

(51) Int. Cl. G06K 9/00

(52) U.S. Cl. 382/141

(57) ABSTRACT

Calibration and normalization methods for a grating-based sensor design are disclosed. The sensor may be constructed in a manner optimized for both label-free and luminescence, e.g. fluorescence, amplification detection in a single device. Such a sensor, based on grating or another periodical structure with appropriate coating, dramatically increases the diversity of applications and allows realizing novel concepts that provide qualitative and quantitative information/data for each location or capture element in the sensor surface. The invention takes advantage of these different modes to carry out a quality control (QC) step and a calibration of each individual location of the sensor. Thus, the assay data can be flagged according to their quality and local density variations, batch variations and variations in the printed deposition of probes or the materials to the surface can be compensated.

### PRIORITY

This application claims priority benefits under 35 U.S.C. § 119(e) to U.S. provisional application Ser. No. 60/921,001 filed Mar. 30, 2007 and to U.S. provisional application Ser. No. 60/998,880 filed Oct. 11, 2007.

### FIELD OF THE INVENTION

This invention relates generally to a method for assessing the quality of an array of probes immobilised on a support, wherein the presence and/or amount of the immobilised probes is assessed individually at each location of the array prior to the potential binding of the labelled analyte.

### BACKGROUND OF THE INVENTION

Microarrays and other assay formats making use of arrays of materials have become powerful tools to increase data quantity and quality in various areas, such as the life sciences, pharmaceutical drug research/development, and recently the clinical environment. Although considered an important key technology, microarray data still suffer various experimental error sources that render long term studies and comparison of data from different laboratories difficult. Production batch and processing batch variations have to be taken into account during experimental design to reduce and control experimental variation.

A key problem for microarray and other array-based technologies is that the amount of immobilized capture element in certain locations on the platform might vary over a wide range (including absent or missing), under the influence of process parameters such as binding capacity of the surface of the platform, concentration of the used capture element solutions, temperature, humidity, incubation time, deposition technology, etc. Quality control of these process steps is therefore very important.

Following hybridisation, the probe-analyte signal depends on both the sequence of immobilized oligonucleotide and the quantity of oligonucleotide immobilized prior to hybridisation. Current methods do not allow for independent determination of the amount of immobilized oligonucleotide. Arrays hybridised with labelled random oligonucleotides specifically designated for calibration do not evenly represent the various sequences present in the of the array population. Another widely used method of calibrating/normalising measurements performed with a microarray or other array based technologies is to make use of reference samples—mixed with the sample of interest during the hybridisation step, wherein both samples carry different fluorescence labels (e.g. CY3/green emission and CY5/red emission). In this method, a constant aliquot of the reference sample is distributed through the entire experiment as a reference. This approach does not solve the problem that signal intensity again, depends on reference sample and capture element sequences. The amount of probe oligonucleotide cannot be determined. In addition, only relative calibration is possible and the calibration of features/sequences of low abundance in the reference sample is poor. For instance, dye swapping might be required to avoid experimental bias.

Other approaches, e.g. such as dye labelling/staining technology, also only assay individual microarrays of a given production batch with above described disadvantages.

The methods of this disclosure are suitable for use with grating-based biosensors which support a label-free detection of a sample and also luminescence/fluorescence amplification of a sample, referred to below as Evanescent Resonance (ER) technology. A brief introduction to both types of sample detection and measurement is set forth below. A detailed explanation of both technologies and a biosensor structure designed for both types of detection is set forth in published PCT patent application WO 2007/019024, the entire contents of which is incorporated by reference herein.

Label-Free Detection Sensors

Grating-based sensors represent a new class of optical devices that have been enabled by recent advances in semiconductor fabrication tools with the ability to accurately deposit and etch materials with precision less than 100 nm.

Several properties of photonic crystals make them ideal candidates for application as grating-type label free optical biosensors. First, the reflectance/transmittance behaviour of a photonic crystal can be readily manipulated by the adsorption of biological material such as proteins, DNA, cells, virus particles, and bacteria on the crystal. Other types of biological entities which can be detected include small and smaller molecular weight molecules (i.e., substances of molecular weight <1000 Daltons (Da) and between 1000 Da to 10,000 Da), amino acids, nucleic acids, lipids, carbohydrates, nucleic acid polymers, viral particles, viral components and cellular components such as but not limited to vesicles, mitochondria, membranes, structural features, periplasm, or any extracts thereof. These types of materials have demonstrated the ability to alter the optical path length of light passing through them by virtue of their finite dielectric permittivity. Second, the reflected/transmitted spectra of photonic crystals can be extremely narrow, enabling high-resolution determination of shifts in their optical properties due to biochemical binding while using simple illumination and detection apparatus. Third, photonic crystal structures can be designed to highly localize electromagnetic field propagation, so that a single photonic crystal surface can be used to support, in parallel, the measurement of a large number of biochemical binding events without optical interference between neighbouring regions within <3-5 microns. Finally, a wide range of materials and fabrication methods can be employed to build practical photonic crystal devices with high surface/volume ratios, and the capability for concentrating the electromagnetic field intensity in regions in contact with a biochemical test sample. The materials and fabrication methods can be selected to optimize high-volume manufacturing using plastic-based materials or high-sensitivity performance using semiconductor materials.

Representative examples of grating-type biosensors are disclosed in Cunningham, B. T., P. Li, B. Lin & J. Pepper, “Colorimetric resonant reflection as a direct biochemical assay technique” Sensors and Actuators B, 81: 316-328 (2002); Cunningham, B. T., J. Qiu, P. Li, J. Pepper & B. Hugh, “A plastic colorimetric resonant optical biosensor for multiparallel detection of label-free biochemical interactions” Sensors and Actuators B, 85: 219-226 (2002); Haes, A. J. & R. P. V. Duyne, “A Nanoscale Optical Biosensor: Sensitivity and Selectivity of an Approach Based on the Localized Surface Plasmon Resonance Spectroscopy of Triangular Silver Nanoparticles” Journal of the American Chemical Society, 124: 10596-10604 (2002).

The combined advantages of photonic crystal biosensors may not be exceeded by any other label-free biosensor technique. The development of highly sensitive, miniature, low cost, highly parallel biosensors and simple, miniature, and rugged readout instrumentation will enable biosensors to be applied in the fields of pharmaceutical discovery, diagnostic testing, environmental testing, and food safety in applications that have not been economically feasible in the past.

In order to adapt a photonic bandgap device to perform as a biosensor, some portion of the structure must be in contact with a test sample. Biomolecules, cells, proteins, or other substances are introduced to the portion of the photonic crystal and adsorbed where the locally confined electromagnetic field intensity is greatest. As a result, the resonant coupling of light into the crystal is modified, and the reflected/transmitted output (i.e., peak wavelength) is tuned, i.e., shifted. The amount of shift in the reflected output is related to the amount of substance present on the sensor. The sensors are used in conjunction with an illumination and detection instrument that directs light into the sensor and captures the reflected or transmitted light. The reflected or transmitted light is fed to a spectrometer that measures the shift in the peak wavelength.

The ability of photonic crystals to provide high quality factor (Q) resonant light coupling, high electromagnetic energy density, and tight optical confinement can also be exploited to produce highly sensitive biochemical sensors. Here, Q is a measure of the sharpness of the peak wavelength at the resonant frequency. Photonic crystal biosensors are designed to allow a test sample to penetrate the periodic lattice, and to tune the resonant optical coupling condition through modification of the surface dielectric constant of the crystal through the attachment of biomolecules or cells. Due to the high Q of the resonance, and the strong interaction of coupled electromagnetic fields with surface-bound materials, several of the highest sensitivity biosensor devices reported are derived from photonic crystals. See the Cunningham et al. papers cited previously. Such devices have demonstrated the capability for detecting molecules with molecular weights less than 200 Daltons (Da) with high signal-to-noise margins, and for detecting individual cells. Because resonantly-coupled light within a photonic crystal can be effectively spatially confined, a photonic crystal surface is capable of supporting large numbers of simultaneous biochemical assays in an array format, where neighbouring regions within <10 μm of each other can be measured independently. See Li, P., B. Lin, J. Gerstenmaier, and B. T. Cunningham, “A new method for label-free imaging of biomolecular interactions.” Sensors and Actuators B, 2003.

There are many practical benefits for label-free biosensors based on photonic crystal structures. Direct detection of biochemical and cellular binding without the use of a fluorophore, radioligand or secondary reporter removes experimental uncertainty induced by the effect of the label on molecular conformation, blocking of active binding epitopes, steric hindrance, inaccessibility of the labelling site, or the inability to find an appropriate label that functions equivalently for all molecules in an experiment. Label-free detection methods greatly simplify the time and effort required for assay development, while removing experimental artifacts from quenching, shelf life, and background fluorescence. Compared to other label-free optical biosensors, photonic crystals are easily queried by simply illuminating at normal incidence with a broadband light source (such as a light bulb or LED) and measuring shifts in the reflected colour. The simple excitation/readout scheme enables low cost, miniature, robust systems that are suitable for use in laboratory instruments as well as portable handheld systems for point-of-care medical diagnostics and environmental monitoring. Because the photonic crystal itself consumes no power, the devices are easily embedded within a variety of liquid or gas sampling systems, or deployed in the context of an optical network where a single illumination/detection base station can track the status of thousands of sensors within a building. While photonic crystal biosensors can be fabricated using a wide variety of materials and methods, high sensitivity structures have been demonstrated using plastic-based processes that can be performed on continuous sheets of film. Plastic-based designs and manufacturing methods will enable photonic crystal biosensors to be used in applications where low cost/assay is required, that have not been previously economically feasible for other optical biosensors.

One of the assignees of the present invention has developed a photonic crystal biosensor and associated detection instrument for label-free binding detection (termed BIND). The sensor and detection instrument are described in the patent literature; see U.S. patent application publications U.S. 2003/0027327; 2002/0127565, 2003/0059855 and 2003/0032039, and U.S. Pat. No. 7,023,544. Methods for detection of a shift in the resonant peak wavelength are taught in U.S. Patent application publication 2003/0077660. The biosensors described in these references include 1- and 2-dimensional periodic structured surfaces applied to a continuous sheet of plastic film or substrate. The crystal resonant wavelength is determined by measuring the peak reflectivity at normal incidence with a spectrometer to obtain a wavelength resolution of 0.5 picometer. The resulting mass detection sensitivity of <1 pg/mm² (obtained without 3-dimensional hydrogel surface chemistry) has not been demonstrated by any other commercially available biosensor.

A fundamental advantage of the biosensor devices described in the above-referenced patent applications is the ability to mass-manufacture with plastic materials in continuous processes at a 1-2 feet/minute rate. Methods of mass production of the sensors are disclosed in U.S. Patent application publication 2003/0017581.

Details on the construction of the system of are set forth in the published U.S. Patent Application 2003/0059855. Another example of periodically structures arrays can also be found in WO 01/02839.

As shown in FIG. 1, the periodic surface structure of a biosensor 10 is fabricated from a low refractive index material 12 that is overcoated with a thin film of higher refractive index material 14. The low refractive index material 12 is bonded to a base sheet of clear plastic material 16. The surface structure is replicated within a layer of cured epoxy 12 from a silicon-wafer “master” mold (i.e. a negative of the desired replicated structure) using a continuous-film process on a polyester substrate 16. The liquid epoxy 12 conforms to the shape of the master grating, and is subsequently cured by exposure to ultraviolet light. The cured epoxy 12 preferentially adheres to the sheet 16, and is peeled away from the silicon wafer. Sensor fabrication was completed by sputter deposition of 120 nm titanium oxide (TiO₂) high index of refraction material 14 on the cured epoxy 12 grating surface. Following titanium oxide deposition, 3×5-inch microplate sections are cut from the sensor sheet, and attached to the bottoms of bottomless 96-well and 384-well microtitre plates with epoxy.

As shown in FIG. 2, the wells 20 defining the wells of the mircotiter plate contain a liquid sample 22. The combination of the bottomless microplate and the biosensor structure 10 is collectively shown as biosensor apparatus 26. Using this approach, photonic crystal sensors are mass produced on a square-yardage basis at very low cost.

The detection instrument for the photonic crystal biosensor is simple, inexpensive, low power, and robust. A schematic diagram of the system is shown in FIG. 2. In order to detect the reflected resonance, a white light source illuminates a ˜1 mm diameter region of the sensor surface through a 100 micrometer diameter fiber optic 32 and a collimating lens 34 at nominally normal incidence through the bottom of the microplate. A detection fiber 36 is bundled with the illumination fiber 32 for gathering reflected light for analysis with a spectrometer 38. A series of 8 illumination/detection heads 40 are arranged in a linear fashion, so that reflection spectra are gathered from all 8 wells in a microplate column at once. See FIG. 3. The microplate+biosensor 10 sit upon an X-Y addressable motion stage (not shown in FIG. 2) so that each column of wells in the microplate can be addressed in sequence. The instrument measures all 96 wells in ˜15 seconds, limited by the rate of the motion stage. Further details on the construction of the system of FIGS. 2 and 3 are set forth in the published U.S. Patent Application 2003/0059855.

Fluorescence Amplification Sensors

U.S. Pat. No. 6,707,561 describes a grating-based biosensing technology that is sometimes referred to in the art as Evanescent Resonance (ER) technology. This technology also employs a sub-micron scale grating structure to amplify a luminescence signal (e.g., fluorescence, chemiluminescence, electroluminescence, phosphorescence signal), following a binding event on the grating surface, where one of the bound molecules carries a fluorescent label. ER technology enhances the sensitivity of fluorophore based assays enabling binding detection at analyte concentrations significantly lower than non-amplified assays.

ER technology makes use of an optical grating in combination with a high refractive index coating (for details see below) to generate optical resonance and to concentrate laser light on the sensor surface where binding has taken place. In practice, a laser scanner scans the sensor at some angle of incidence (theta), typically from above the grating, while a detector detects fluoresced light (at longer optical wavelength) from the sensor surface. Also, non-scanning optical set-ups that use CCD (Charge Coupled Devices) cameras to measure larger areas of the sensors at a time can be configured to generate evancesent resonance. By design, ER sensor optical properties result in nearly 100% reflection, also attributed as resonance, at a specific angle of incidence and laser wavelength (λ). Confinement of the laser light by and within the grating structure amplifies emission from fluorophores bound within range of the evanescent field (typically 1-2 um). Hence, at resonance, transmitted light intensity drops to near zero.

As noted above, the label-free biosensors described in the above-referenced patent applications employ a sub-micron scale grating structure but typically with a significantly different grating geometry and objective as compared to gratings intended for ER use. In practical use, label-free and ER technologies have different requirements for optical characteristics near resonance. The spectral width and location of the resonance phenomena describes the primary difference. Resonance width refers to the full width at half maximum, in wavelength measure, of a resonance feature plotted as reflectance (or transmittance) versus wavelength (also referred to as Q factor above). Resonance width can also refer to the width, in degrees, of a resonance feature plotted on a curve representing reflectance or transmittance as a function of theta, where theta is the angle of incident light.

Optimally, a label-free grating-based sensor produces as narrow a resonance peak as possible, to facilitate detection of small changes in peak position indicating low binding events. A label-free sensor also benefits from a high grating surface area in order to bind more material. In current practice, one achieves higher surface area by making the grating deeper (though other approaches exist). Current commercial embodiments of label-free sensors produce a resonance near 850 nm, thus BIND label-free detection instrumentation has been optimized to read this wavelength.

Conversely, practical ER grating sensor designs employ a relatively broad resonance to ensure that resonance occurs at the fixed wavelength laser light and often fixed angle of incidence in the presence of physical variables such as material accumulation on the grating or variation in sensor manufacture. Because field strength generally decreases with resonance width, practical ER sensor design calls for a balance in resonance width. By choosing an appropriate ER resonance width, one ensures consistent amplification across a range of assay, instrument and sensor variables while maintaining ER signal gain. A typical application uses a 633 nm wavelength to excite a popular fluorescent dye, known in the art as Cy5. Some ER scanning instrumentation permits adjustments to incident angle to “tune” the resonance towards maximum laser fluorophore coupling. This practice, however, may induce an unacceptable source of variation without proper controls.

Known ER designs also employ more shallow grating depths than optimal label-free designs. For example, the above-referenced U.S. Pat. No. 6,707,561 specifies the ratio of grating depth to “transparent layer” (i.e., high index coating layer) thickness of less than 1 and more preferably between 0.3 and 0.7. Optimal label-free designs employ gratings with a similarly defined ratio of greater than 1 and preferably greater than 1.5. Label-free designs typically define grating depth in terms of the grating line width or half period. For example, currently practiced commercial label-free sensors have a half period of 275 nm and a grating depth of approximately 275 nm, thus describing a 1:1 geometric ratio. This same sensor design employs a high index of refraction oxide coating on top of the grating with a thickness of approximately 90 nm. Thus, according to the definition in the U.S. Pat. No. 6,707,561, this sensor has a grating depth:oxide thickness ratio of approximately 3:1.

### SUMMARY OF THE INVENTION

The present disclosure provides for calibration and normalization uses of grating-based biosensor designs. The biosensors may be constructed in a manner such that that the biosensor is optimized for both modes of detection (label-free and luminescence, e.g. fluorescence, amplification), in a single device. Such a sensor, based on grating or another periodical structure with appropriate coating, dramatically increases the diversity of applications and allows realizing novel concepts that provide qualitative and quantitative information/data for each location in the microarray/biosensor.

The present disclosure takes advantage from these different modes to carry out quality control (QC) steps at various stages of the sensor preparation and a calibration of each individual location of the biosensor. Thus, the assay data can be flagged according to their quality and local density variations, and batch or printing variations of the biosensor can be compensated.

The present disclosure makes use of the ER and label-free technologies in a combination that allows obtaining qualitative/quantitative information as well as calibration for all capture elements immobilized and for all microarrays that are produced in a batch (intra batch). The methods of the present invention also allow compensating for production batch differences (inter batch). The biosensors for use in the inventive methods may be based on periodically structured microarrays substrates with thin dielectric coatings, as described in e.g. patents WO01/02839, US2003/0027327; US2002/0127565, US2003/0059855 or US2003/0032039, or in U.S. Pat. Nos. 6,707,561 or 7,023,544. These structures can also be described as photonic crystals or photonic band gap materials.

In one aspect, the present disclosure provides a method for assessing the immobilisation quality and/or quantity of the probes of an array of probes immobilised on a support. The presence and/or amount of the immobilised probes are assessed individually at each location of the array in a spatially resolved manner prior to the potential binding of the analyte.

In one embodiment, the support has an optically transparent substrate having a refractive index n₁, and a non-metallic optically transparent layer formed on the surface of the substrate, said layer having a refractive index n₂ which is greater than n₁, wherein said support incorporates therein one or more grating or corrugated structures which define one or more sensing areas or regions, each for one or multiple capture elements or locations, wherein said corrugated structure comprising periodic grooves. The depth of the grooves is in the range of 3 nm to the thickness of the optically transparent layer. The thickness of the optically transparent layer is in the range of 30 to 1000 mn. The period of the corrugated structure is in the range of 200 to 1000 nm, the ratio of groove depth to the thickness of the optically transparent layer is in the range of 0.02 to 1, and the ratio of groove width to the period of the grooves is in the range of 0.2 to 0.8. Thus, in an ER mode, coherent light incident on said support at an appropriate angle can be diffracted into individual beams or diffraction orders which interfere resulting in reduction of the transmitted beam and an abnormal high reflection of the incident light, thereby generating an evanescent field at the surface of the one or multiple sensing areas. Alternatively, coherent and linearly polarised light incident on the platform at an appropriate angle can be diffracted into individual beams or diffraction orders which interfere resulting in almost total extinction of the transmitted beam and an abnormal high reflection of the incident light, thereby generating an evanescent field at the surface of the one or multiple sensing areas or locations.

The presence and/or amount of each of the materials immobilized on the support or biosensor surface is measured in a label-free mode, comprising measurement of peak wavelength value (PWV) data of the support or regions of the support at all stages of the processes used for the production/preparation, in particular prior and post material immobilisation (printing/arraying, microarray production), wherein changes of the PWV data can be used to construct 2-dimensional images of the transducer in spatially resolved manner (PWV images). These images provide quantitative information of the respective process steps. In particular, the PWV data/images are indicative for the amount and morphology of potentially immobilized material. The PWV data/images can be used to quantify the immobilized material on the transducer and can be used for assessment of quality, spatially resolved quantification of material immobilized on the biosensor, and can be used in downstream data/image processing to calibrate data and images obtained after hybridisation with labelled sample (luminescence, fluorescence or other labels).

In one embodiment, the present disclosure provides a method wherein the label-free PWV data/images and/or ER measurements can be carried out at all stages of the process, prior/post the support/transducer surface cleaning, surface modification, immobilisation of materials, wash steps, drying steps, hybridisation of sample; independent from the sequence/order, wherein processing steps can also be repeated or used at several stages of the process in an adapted/suitable way.

In another embodiment, the present disclosure provides a method wherein the signals of the post-hybridisation images steps can be corrected based on the pre-hybridisation PWV images/data, thus calibrating/compensating for variations of amount and morphology of immobilized capture material immobilised on the biosensor.

In yet another embodiment, the present disclosure provides a method wherein the sensor surface is coated with a layer of nanoparticles consisting of material having a refractive index n₂ higher than that of the substrate n₁. The nanoparticles attached to the surface are of similar size and act as periodical structure/arrangement that allows optical coupling/resonance of the device/transducer/support as described herein. The size of the nanoparticles is preferentially between 10 and 1000 nm, and the resulting periodicity is in the range of 100 to 1000 nm, and the substrate is of planar, cylindrical, conical, spherical, or elliptical geometry.

In still another embodiment, the present disclosure provides a method wherein a salt image is further obtained of the biosensor and analysed. The salt image results from a method of spotting the probes to be immobilised to the support. The method of spotting includes steps of spotting a salt containing-solution containing the probes to be immobilised to the support, optionally drying the salt containing-solution containing the probes, and obtaining an image of the locations where the probes should have been immobilised. The image is obtained prior to any washing step, so that the absence of salt at a specific location indicates that spotting of the probe to be immobilised at this specific location has not occurred.

The present disclosure also provides a method wherein the optically transparent substrate is made of organic and/or inorganic materials, e.g. glass, quartz, metal oxides, dielectric materials, inorganic or organic high refractive index materials, silicon, polymers, plastic, PET, PC, PU, adhesive layers and combination of these materials. Materials which exhibit low background fluorescence are considered preferred.

In one embodiment, the optically transparent layer is formed from inorganic material, for instance a metal oxide such as Ta₂O₅, TiO₂, Nb₂O₅, ZrO₂, ZnO or HfO₂, or from organic material, for example polyamide, polyimide, PP, PS, PMMA, polyacryl acids, polyacryl esters, polythioether, or poly(phenylenesulfide) and derivatives thereof.

In one embodiment, the immobilized material, and/or analyte/sample molecules, and/or additional components/species required for the assay are labelled or modified with spacer molecules, Energy-donors, Energy-Acceptors, Electron-Donors, Electron-Acceptors, chromophores, luminophores, fluorophores, phosphorescence labels, spectroscopic labels, biological functions, or chemical modifications.

In one embodiment, the probe and/or samples and/or other species (Spacers, Energy-donors, Energy-acceptors, Electron-Donors, Electron-Acceptors) participating at the assay are unlabeled.

The evanescent resonance (ER) data/images can be calibrated using the quantitative information, i.e. PWV images/data. Moreover, the label-free/PWV data and/or images are calibrated using the quantitative information, i.e. PWV images/data.

The method can also involve a step of obtaining spectrum/data for background signals produced by the biosensor and wherein the quantitative information is obtained after subtraction of the spectrum for background signals.

In another aspect, the present disclosure provides a method of detecting and/or quantifying an analyte using an array of immobilised probes, wherein the presence and/or concentration of the analyte is normalised with respect to the presence and/or concentration of said immobilised probes, wherein the presence and/or concentration of the immobilised probes is assessed individually at each location of the array prior to the potential binding of the analyte.

In one embodiment, the background subtraction methods are applied to compensate for background levels for all types of images. Any suitable background subtraction method known in the art may be used, and the details are not particularly important.

In another embodiment, the data/images obtained at different stages of the process can be used to calculate new images or data using suitable algorithms, e.g. for calibration, and/or background correction. The microarray may be preprocessed or processed to prepare the hybridization of a sample. The sample is then hybridized to the microarray/support, a post-hybridisation process for the microarray/support is applied, and a luminescence-based post-hybridisation image is recorded in luminescence mode of the microarray/support. The resulting image represents the bound luminescence-labelled analyte material. Alternatively or additionally, a post-hybridisation label free image can be recorded in the label-free mode. This represents the immobilized material/capture probes and the bound material originating from the sample incubation.

The background subtraction methods may be applied to compensate for background levels for all types of images. In addition, the signals of the post-hybridisation images can be corrected based on the pre-hybridisation data obtained previously, thus calibrating/compensating for capture material variations on the microarray.

In yet another aspect, the present disclosure provides a method of analysis of a microarray comprising a multitude of sample regions, each sample region potentially containing labelled or unlabeled capture probes bound to the microarray, and wherein the microarray is formed as a surface of a periodic grating structure. The steps of the method include: (a) obtaining a two-dimensional image of the microarray; (b) obtaining peak wavelength value (PWV) data for the portions of the image which comprise images of capture probe regions of the array, the peak wavelength value comprising the peak wavelength of light reflected from the array due to resonant coupling of light into the grating structure; and (c) obtaining quantitative information as to the amount of binding/deposition/immobilisation of the capture probe to the sample regions of the array from the peak wavelength value data.

In another embodiment, the method further comprises the steps of (d) applying labelled samples (e.g. luminescence fluorescence) to the sample regions; (e) obtaining evanescent resonance (ER) measurements of the sample regions; and (f) normalizing the ER measurements with the quantitative information obtained in step c).

In yet another embodiment, the method further includes the step of obtaining PWV data for background signals produced by the microarray and wherein the quantitative information in step c) is made after subtraction of the PWV data for the background signals.

The labelled samples can be selected from the group of materials consisting of nucleic acids, proteins and protein fragments, peptides, any biological relevant binding partners, cells or fragments thereof, chemical sensing compounds, etc.

In still another embodiment, the method further includes the step of obtaining qualitative or quantitative data as to the binding/immobilisation of sample material to the array from analysis of either the two-dimensional image or the peak wavelength value data.

The array elements (capture elements) can be applied to the microarray/biosensor/substrate platform with a suitable device or systems, such as for example a microarray printer, a Pin Printer, an Ink-Jet printer, a photoimmobilisation system, or other technique either known in the art or later developed. In one embodiment, the capture elements material is applied or deposited using a piezo-array printer.

In another aspect, the present disclosure provides a non-contact method of qualitative analysis of a printed microarray chip, including the steps of (a) providing a microarray or biosensor in the form of a multitude of sample regions on a surface of a periodic grating structure; (b) deposition of capture elements to the microarray; (c) obtaining a two-dimensional image of the microarray; (d) obtaining peak wavelength value (PWV) data for the portions of the two-dimensional image which comprise images of sample regions of the microarray, the peak wavelength value comprising the peak wavelength of light reflected from the microarray due to resonant coupling of light into the grating structure; and (e) obtaining qualitative information as to the binding of the capture elements to/on the sample regions of the microarray from either (1) the two-dimensional image or (2) the peak wavelength value data.

The qualitative or quantitative information obtained by the method in step (e) can be by determining the amount of bound/immobilized material as a function of the position on the substrate.

The capture elements can be selected from the group of materials consisting of a nucleic acid material and a protein or chemical/biological/physically/optically modified derivatives/fragments thereof. In general, any capture element of organic, inorganic, biological or chemical nature can be used for sensor preparation.

In yet another aspect, the present disclosure provides a method of analysis of a microarray chip including the steps of: (a) providing a microarray chip in the form of a multitude of immobilized capture elements on a surface of a periodic grating structure; (b) applying a biological material/sample to the immobilization capture elements; (c) obtaining a two-dimensional image of the microarray; (d) obtaining peak wavelength value (PWV) data for the portions of the two-dimensional image which comprise images of sample regions of the microarray, the peak wavelength value comprising the peak wavelength of light reflected from the microarray due to resonant coupling of light into the grating structure; (e) performing a hybridisation step comprising applying a sample material to the immobilization capture elements; (f) obtaining a two-dimensional image of the microarray after the hybridisation step; and (g) obtaining peak wavelength value (PWV) data for the portions of the two-dimensional image which comprise images of sample regions of the microarray after the hybridisation step.

The hybridisation step can include applying a luminescent or fluorescent probe to the biological material. Obtaining evanescent resonance (ER) measurements of the sample regions can be done after the hybridisation step. The ER measurements are normalized with reference to quantitative data of the amount of biological material bound to the sample regions obtained from the peak wavelength value (PWV) data obtained in step (d).

The present disclosure provides a method for the quality control of a DNA microarray where statistical robustness criteria are established for the use of the quality control data determined by label-free methods.

The present disclosure further provides a method for the determination of the amount of DNA adhered to a biosensor prior to and following various protocols/processes (e.g., hybridisation) comprising the use of label-free and label methods.

### DESCRIPTION OF THE FIGURES

Exemplary embodiments are illustrated in the drawings. It is intended that the embodiments and figures disclosed herein are to be considered illustrative rather than restrictive.

FIG. 1 is an illustration of a prior art grating-based biosensor arrangement.

FIG. 2 is an illustration of a prior art biosensor and detection system for illuminating the biosensor and measuring shifts in the peak wavelength of reflected light from the biosensor.

FIG. 3 is an illustration of an arrangement of 8 illumination heads that read an entire row of wells of a biosensor device comprising the structure of FIG. 1 affixed to the bottom of bottomless microtitre plate or other suitable liquid-containing vessel.

FIGS. 4A and 4B are perspective and cross-sectional views, respectively, of a two-dimensional grating design characterized by periodic holes in a grating structure which is optimized for BIND (label-free) detection in a water environment when illuminated by X polarized light and optimized for ER detection in an air environment when illuminated by Y polarized light.

FIGS. 5A and 5B are perspective and cross-sectional views, respectively, of a two-dimensional grating design characterized by periodic posts in a grating structure which is optimized in one direction for BIND (label-free) detection in a water environment when illuminated by X polarized light and optimized for ER detection in an air environment when illuminated by Y polarized light.

FIGS. 6A-6C are three views of a unit cell showing a two-level, two-dimensional grating structure for yet another embodiment of a combined ER and label-free sensor.

FIG. 7 is a schematic drawing of an imaging readout system for a combined ER and label-free grating-based sensor.

FIG. 8 is an image of a biosensor in the form of a microarray which is captured by the CCD camera in a detection system (such as shown in FIG. 7), the biosensor having a periodic grating structure such as shown in FIG. 11, having a multiplicity of capture elements.

FIGS. 9A-9C shows three different images of a portion of one of the capture element regions of the biosensor of FIG. 8, in which individual capture element locations are indicated by a circle in FIGS. 9A, 9B, and 9C.

FIG. 9A is a “salt image” of one of the regions of FIG. 8 which shows the printed spots or locations that are expected to consist of capture elements (e.g. oligonucleotide) and print buffer. The actual morphology of the spot locations in the image is varying and depends on the process conditions. The image provides only qualitative information, e.g. spots where capture materials have not been printed/deposited correctly on the chip surface. This information can be used as basic quality flags for each of the capture elements.

FIG. 9b is a label-free, PWV image of the region of FIG. 9A, obtained after a washing step that removes the excess material from the biosensor surface. The intensity of the individual locations corresponds to the amount of immobilized material of the oligonucleotides which are immobilized/deposited in the individual locations on the microarray. The intensity measurements (“BIND” data) are made using the system of either FIG. 3 or 7, or in another type of detection system. The shift in peak resonance wavelength measured by the detection system is determined on a pixel-by-pixel basis and the magnitude of such shifts is converted either to colours or to relative brightness, or both, for purposes of rendering the label-free image of FIG. 9B.

FIG. 9C is an image obtained with the system of FIG. 7 in an ER mode showing the fluorescence intensity of the regions corresponds to the abundance of a particular mRNA in the used sample.

FIG. 10 illustrates alternative forms of a biosensor platform, including: discs, concentric designs, etc., as shown in International Patent Application WO 01/02839. The sensing elements (see FIG. 10a) can be arranged in various ways, for instance rectangular, circular, hexagonal-centric, ellipsoidal, linear or labyrinthine. The sensing area (see FIG. 10b) may be rectangular, round or of any other shape. The grooves may be arranged either equidistant linear or equidistant circular, or may correspond to segments of such structures. The platform (see FIGS. 10c to 10f) can be either rectangular or disc-shaped, or of any other geometry. The platform can comprise one or multiple sensing areas, each sensing area can comprise one or multiple capture elements, and each capture element can comprise one or multiple labeled or unlabelled capture molecules. The platform can also be adapted to microtitre-type plates/devices (see FIG. 10g) in order to perform one or multiple assays in the individual microtitre wells. This can be achieved for all plate types: 96, 384, 1536, or higher numbers of wells, independently of the dimensions of the respective microtitre-plate.

FIG. 11 shows a schematic view of an ER sensor similar to that shown in FIGS. 8 and 9.

FIG. 12 shows a schematic view of an ER/BIND composite sensor.

FIGS. 13A and B are two views of a unit cell of an ER/BIND composite sensor as shown in FIG. 12, where the grating depth<thickness of high refractive index layer.

FIGS. 14A and 14B are two views of a unit cell of an ER/BIND composite sensor as shown in FIG. 12, where the grating depth>thickness of high refractive index layer.

### DETAILED DESCRIPTION

The methods of this disclosure may use a biosensor constructed as a periodic surface grating in which so-called evanescent resonance can be created. Evanescent resonance is a phenomenon which has been described theoretically in the prior art for example in a paper entitled “Theory and applications of guided mode resonance filters” by S S Wang & R Magnusson in Applied Optics, 32(14): 2606 to 2613 (10 May 1993) and in a paper entitled “Coupling gratings as waveguide functional elements” by O. Parriaux et al, Pure & Applied Optics 5: 453-469 (1996). As explained in these papers resonance phenomena can occur in planar dielectric layer diffraction gratings where almost 100% switching of optical energy between reflected and transmitted waves occurs when the grooves of the diffraction grating have sufficient depth and the radiation incident on the corrugated structure is at a particular angle. This phenomenon is exploited in the sensing area of the platform where that sensing area includes diffraction grooves of sufficient depth and light is caused to be incident on the sensing area of the platform at an angle such that evanescent resonance occurs in that sensing region. This creates in the sensing region an enhanced evanescent field which is used to excite samples under investigation. It should be noted that the 100% switching referred to above occur with parallel beam and linearly polarised coherent light and the effect of an enhanced evanescent field can also be achieved with non-polarised light of a non-parallel focussed laser beam. Excitation photons incident on the chip under resonance conditions couple onto a thin corrugated metal oxide surface at the site of incidence. As a result of the transducer geometry, the energy is locally confined into the thin corrugated layer of high refractive index material. Consequently, strong electromagnetic fields are generated at the surface of the chip. The effect has been attributed as evanescent resonance and leads to increased fluorescence intensity of chromophores close to the surface. The effective field strength can be increased up to 100-fold by the confinement of the available excitation energy, depending on the optical properties of the used optical detection system.

At resonance conditions, the individual beams interfere in such a way that the transmitted beam is cancelled out (destructive interference) and the reflected beams interfere constructively, giving rise to abnormal high reflection. By choosing appropriate parameters for the above mentioned corrugated layer structure the excitation energy remains highly localized. Such structures are described in the literature as photonic band gap structures, materials with periodic spatial variations of their refractive index such that electromagnetic radiation cannot propagate in a particular direction for a particular range of wavelengths. Photonic bandgap structures allow highly localized modes to appear, see e.g. the paper entitled “Localisation of One Photon States” by C. Adlard, E. R. Pike & S. Sarkar in Physical Review Letters, Vol. 79, No 9, pages 1585-87 (1997). Such structures exhibit extremely large propagation losses corresponding to a mode localisation. The biosensor or transducer (both terms are used interchangeably herein) of the present disclosure can be considered as optically active in contrast to optically passive platforms constructed from e.g. a glass or polymer. Here, optically active means increasing the electromagnetic field of the excitation beam by energy confinement.

The substrate of the biosensor may be formed from inorganic materials such as glass, SiO2, quartz, silicon, and of different organic and inorganic components or layer as composite materials. Alternatively the substrate can be formed from organic materials such as polymers preferably polycarbonate (PC), poly (methyl methacrylate) (PMMA), polyimide (PI), polystyrene (PS), polyethylene (PE), polyethylene terephthalate (PET) or polyurethane (PU). Substrate materials can also include polycarbonate or cyclo-olefin polymers such as Zeanor®.

These organic materials are especially preferred for point-of-care (POC) and personalized medical applications since glass is not accepted in such an environment. Plastics substrates can be structured (e.g. embossed) much more easily than glass.

The non-metallic optically transparent layer may be formed from inorganic material. Alternatively it can be formed from organic material. In one example the optically transparent layer is a metal oxide such as Ta₂O₅, TiO₂, Nb₂O₅, ZrO₂, ZnO or HfO₂.

Alternatively the non-metallic optically transparent layer can be made of organic material such as polyamide, polyimide, polypropylene (PP), PS, PMMA, polyacryl acids, polyacryl ethers, polythioether, poly (phenylenesulfide), and derivatives thereof (see for example S. S. Hardecker et al., J. of Polymer Science B: Polymer Physics, Vol. 31, 1951-63, 1993).

The depth of the periodic grating or grooves is in the range 3 nm to the thickness of the optically transparent layer and preferably 10 nm to the thickness of the optically transparent layer, e.g. 30 nm to the thickness of the optically transparent layer. The thickness of the optically transparent layer is in the range 30 to 1000 nm, e.g. 50 to 300 nm, preferably 50-200 nm, the period of the corrugated structure may be in the range 200 to 1000 nm, e.g. 200 to 500 mm, preferably 250-500 nm, the ratio of the groove depth to the thickness of the optically transparent layer lies in the range 0.02 to 1 e.g. 0.25 to 1, preferably 0.3 to 0.7, and the ratio of the grooves width to the period of the grooves (“duty-cycle”) lies in the range 0.2 to 0.8, e.g. 0.4 to 0.6.

The grooves may be generally rectangular in cross-section. Alternatively, the grooves may be sinusoidal or of saw tooth cross-section. The surface structure may be generally symmetrical. Preferred geometries include rectangular, sinusoidal and trapezoidal cross-sections. Alternatively, the grooves may be of saw tooth cross-section (blazed grating) or of other asymmetrical geometry. In another aspect the groove depth may vary, e.g. in periodic modulations.

The support or platform may be square or rectangular and the grooves may extend linearly along the platform so as to cover the surface. Alternatively the platform may be disc shaped and the grooves may be circular or linear.

The grooves (or raised portions) may be formed on a surface of the substrate. Alternatively the grooves may be formed on a surface of the optically transparent layer. As a further alternative, grooves may be formed both on the surface of the substrate which is the interface and on the surface of the optically transparent layer. The grating structure can take variety of one and two dimensional forms, including two-level, two dimensional gratings, as disclosed in published PCT application WO 2002/0179024, the contents of which are incorporated by reference herein.

The corrugated surface of a single sensing area may be optimized for one particular excitation wavelength and for one particular type of polarisation. By appropriate means, e.g. superposition of several periodic structures which are parallel or perpendicular one with another, periodic surface relief can be obtained that are suitable for multiple wavelength use of the platform (“multicolour” applications). Alternatively, individual sensing areas on one platform may be optimized for different wavelengths and/or polarisation orientations.

The design of corrugated (grating) surface can be developed and its performance modelled with the aid of a computer and a software program GSolver (Grating Solver Development Co., Allen Tex., www.gsolver.com). The various geometrical dimensions and parameters, spacing, well depth, materials, and index of refraction data associated with the materials allows the design to be studied on a computer and simulations run to predict the Transmission v. Theta curve and reflection as a function of wavelength curve. Such simulations can be run in situations where the sample is dry and when the sample is suspended in water or other fluid medium with known index of refraction. Such simulations allow the designer to optimize (i.e., change) the various design parameters (thicknesses, transitions, period, etc.) to satisfy the requirements for both ER and label-free detection.

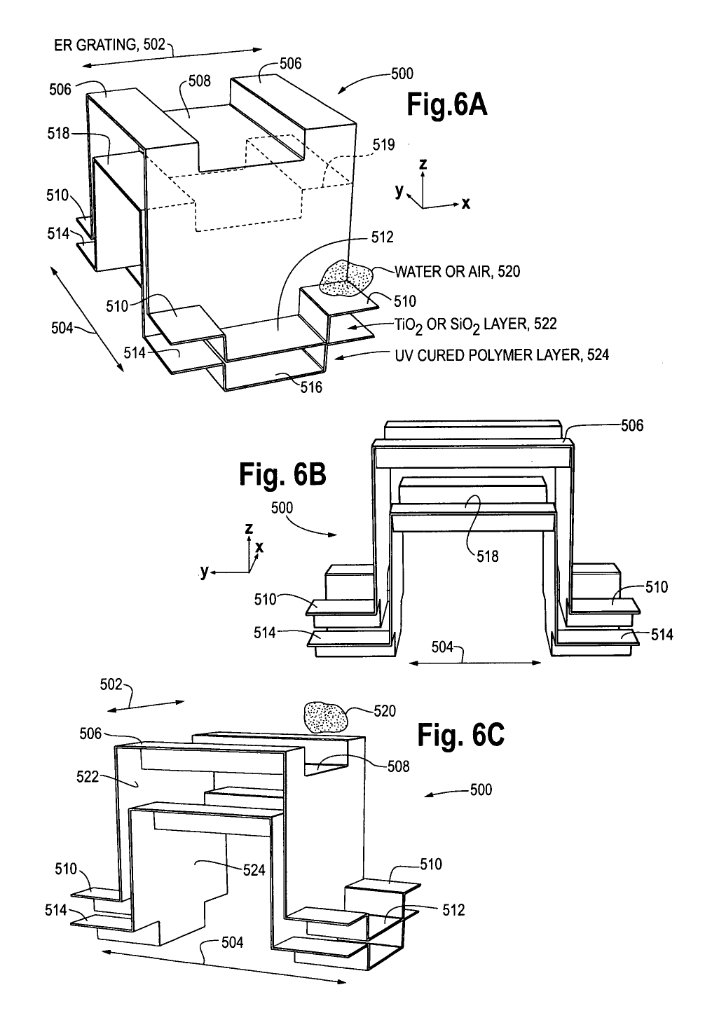

The present inventive calibration and normalization methods can be performed using a biosensor constructed in a manner which is optimized for both label free (BIND) and ER measurements. Such a biosensor can have a one-dimensional grating structure in the horizontal plane, a two dimensional grating structure, or two-level, two dimensional grating structures. Several possible and nonlimiting examples of such a biosensor will be described in conjunction with FIGS. 4A-4B, 4A-5B and 6A-6C.

FIGS. 4A and 4B show one specific example of a 2D “holes” embodiment of a combined BIND and ER biosensor. The biosensor is constructed in two dimensions so as to be optimized for both ER and label-free (BIND) detection using a single device. FIGS. 4A and 4B provide perspective and cross-sectional views, respectively, of a unit cell for a two-dimensional grating design characterized by periodic holes 210 in a grating structure. The grating design optimizes for water mode BIND (label-free) detection and air mode ER detection. The device includes an upper TiO₂ layer 104 of 78 nm thickness and a lower substrate 102 layer of UV-cured material having a grating pattern as shown applied to a base substrate sheet.

The two-dimensional unit cell shown in FIGS. 4A and 4B is designed in such a way that incident light polarized perpendicular to the X-axis, as shown, produces a BIND signal, incident light polarized perpendicular to the Y-axis enables ER measurement. Using this design method, the BIND and ER resonant wavelengths (at a particular angle of incidence—preferably near normal incidence) may be chosen independently, and so the respective BIND and ER resonant wavelengths may occur at very different values. The combined BIND/ER structure described in this embodiment is optimized to provide a BIND resonance in the near infrared (˜800-900 nm) wavelength region, while providing an ER resonance at 632.5 nm for excitation of the Cy5 fluorophore. In this example, the design assumes a water environment over the sensor during BIND measurement and an air environment over the sensor during ER measurement. The differing wavelength requirements for ER and BIND engender selection of a unit cell with a rectangular “hole” (210). Thus, the unit cell may have differing dimensions in the X and Y directions. For example, the period in the X direction is 550 nm for the BIND wavelength, but is 432 nm in the Y direction as required for the lower wavelength ER resonance. The fabrication process dictates that the high refractive index dielectric thickness will be the same in the X and Y directions. For fabrication simplicity, the design also has uniform grating depth. The fabrication process will also result in rounding of the hole corners, however the principal function of the design remains unchanged. One skilled in the art will appreciate that when a computer is used to generate and test a design such as shown in FIGS. 4A and 4B, the designer can change the specific dimensions of the unit cell, grating depth, and coating layers and run simulations of field intensity, peak wavelength, reflectance as a function of theta, and other tests and may select other dimensions while still achieving acceptable results. Thus, the example of FIGS. 4A and 4B is meant to be an illustrative embodiment and not limiting in scope.

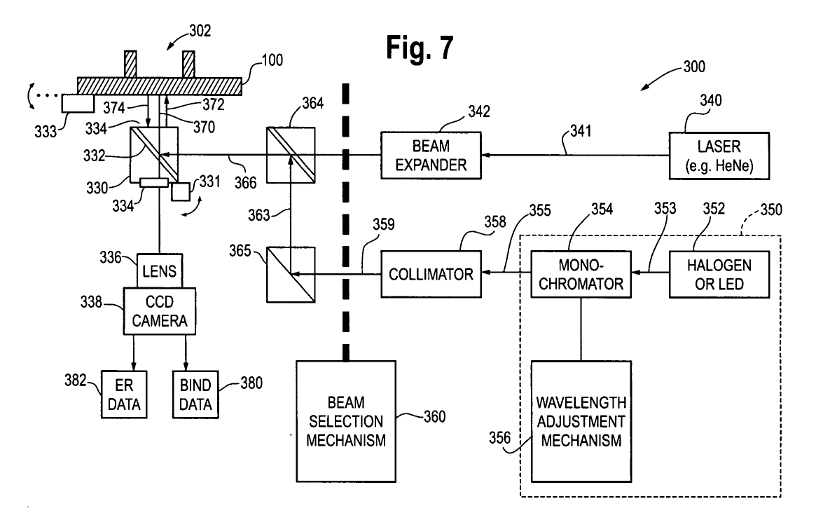

A 2-dimensional grating structure using a repeating unit cell characterized by a post will now be described with reference to FIGS. 5A-5B. FIGS. 5A and 5B are perspective and cross-sectional views, respectively, of a unit cell of 2-dimensional grating design characterized by periodic posts 220 formed in the sensor surface. Each unit cell has one post 220. The posts 220 are raised projections in a substrate material 102 (e.g., UV cured polymer) which is applied to a base sheet (not shown). A high index of refraction (e.g., TiO₂) coating is applied to the projections and substrate as shown in the Figures. The structure is optimized for BIND (label-free) detection in a water environment using light polarized in the X direction and optimized for ER detection in an air mode, using light polarized in the Y direction.

The design of FIGS. 5A and 5B was studied by Rigorous Coupled Wave Analysis (RCWA) computer simulation. While the previous structure unit cell of FIGS. 4A and 4B contained a “hole” region surrounded by regions at a higher plane in the z-direction, the grating structure of FIGS. 5A and 5B contains a central “post” region, surrounded by regions at a lower plane in the z-direction. As before, the design of FIGS. 5A and 5B represents a BIND/ER combined structure that is optimized to provide a BIND resonance in the near infrared (˜800-900 nm) wavelength region, while providing an ER at 632 nm for excitation of the Cy5 fluorophore. In this example, the design again assumes a water environment over the sensor during BIND measurement and an air environment over the sensor during ER measurement. These differing wavelength requirements for ER and BIND engender selection of a rectangular “post” unit cell. Thus, the unit cell may have differing dimensions in the X and Y directions. For example, the period in the X direction is 530 nm for the BIND wavelength, but is 414 nm in the Y direction as required for the lower wavelength ER resonance. The fabrication process again dictates that the high refractive index dielectric thickness will be the same in the X and Y directions. For fabrication simplicity, the design also has uniform grating depth. The fabrication process will also result in rounding of the post corners, however the principal function of the design remains unchanged. The example of FIGS. 5A and 5B is meant as an illustrative example not limiting in scope. The specific dimensions can of course vary.

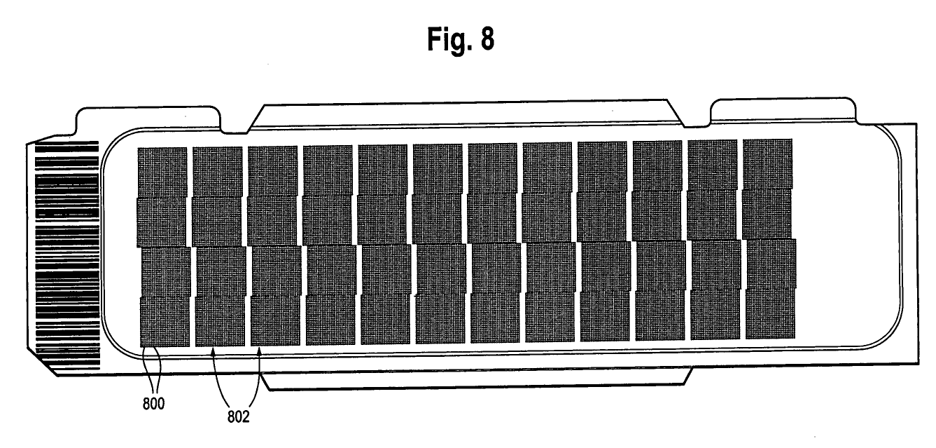

FIGS. 6A-6C are three perspective views of yet another embodiment of a unit cell 500 for a biosensor grating structure constructed and designed for a combined ER and label-free (BIND) detection. In order to appreciate some of the features of this structure, it will be useful to recapitulate on the design aspects pertinent to evanescent resonance (ER) and label-free (BIND) sensors. Such sensors differ in three basic design aspects, namely: resonance wavelength, resonance width, and grating depth.

Resonance Wavelength

The ER sensor prefers resonance to occur in within a few (˜+/−2) nm of the excitation wavelength. Given that the excitation light generally comes from a laser and has very narrow bandwidth, this requirement places high specificity on the wavelength location of the ER resonance. The BIND mode of operation does not have this limitation and may benefit from a resonance at another wavelength e.g. outside ambient lighting wavelength range or to separate the BIND signal spectrally from the ER excitation source thereby eliminating potential overlapping detection conflicts.

Resonance Width

The ER sensor must have a resonance wide enough for it to overlap the excitation wavelength in the presence of variables such as biological coating thickness and illumination numerical aperture. In practice, the ER resonance should not have a full width at half maximum (FWHM) less than about 5 nm, and more preferably between 10 and 15 nm. On the other hand, BIND sensitivity increases approximately as 1/sqrt (FWHM) because peak location uncertainty decreases as the peak width narrows.

Grating Depth

BIND sensors give greater resonance wavelength shift when more biological material adheres to the grating. A deeper grating offers more surface area for binding biological material. The ER effect does not necessarily improve and may degrade as the ER grating depth increases.

The 2-D designs described previously have uniform grating depth (e.g. in the post examples the height of the posts, or in the holes example the depth of the holes). Selecting a single grating depth may involve a compromise between BIND and ER performance both in terms of peak width and surface area, i.e. BIND PWV shift.

The design of the biosensor of FIG. 6A-6C is a two-level, two-dimensional design. The specifics of the design will be discussed below in greater detail. This design maintains a narrow TM BIND resonance and high BIND shift performance, while simultaneous providing a wider TE ER resonance. Similar to previously described two-dimensional designs, the BIND and ER gratings can have different periods and hence independently determined resonance wavelengths.

This “two level” “comBIND” design of FIG. 6A-6C comprises a multitude of repeating unit cells 500, each of which superimposes a relatively shallow ER grating 502 extending in the X direction on a relatively deep BIND grating 504, extending in the Y direction. FIGS. 6A-6C depict one “unit cell” 500 for this design, which, when replicated in the XY plane forms the complete grating.

The unit cell 500 consists of a UV-cured polymer layer 524 which is applied using a master grating wafer to a base substrate sheet such as PET film (not shown). The polymer layer 524 has the structure of the BIND grating 504, namely alternating low and high regions extending in the Y direction. In the X direction, the grating also has alternating low and high regions, although the relative height of the high region compared to the low regions of the UV-cured polymer layer 524 in the X direction is much less than in the Y direction.

A TiO₂ (or alternatively SiO₂ or Ta₂O₅) layer 522 is deposited over the UV-cured polymer layer. This layer has uniform thickness in the illustrated embodiment. The layer 522 includes upper repeating surface 506, 508, 510, and 512, and lower repeating surface 514, 516, 518 and 519. The lower surfaces 514, 516, 518 and 519 are positioned over the top surface of the UV-cured polymer layer. An air or water sample medium 520 is placed in contact with the upper surfaces 506, 508, 510, 512 of the TiO₂ or SiO₂ layer 522.

As will be appreciated from inspection of FIGS. 6A-6C, the “two-layer 2-D” grating structure includes a relatively deep BIND grating 504 in the Y dimension, characterized by upper and lower grating surfaces 506/508 and 510/512, respectively. The BIND aspect of the unit cell thus permits adding or more sample material and allows more material to adhere to the grating, permitting a greater resonance shift. The deeper grating in the BIND (Y direction) offers more surface area for binding biological material.

The ER grating 502 extending in the X direction, conversely, consists of a relatively shallow grating pattern with high regions 506 and low regions 508 (and also high region 510 and low region 512). In addition to providing good BIND detection capability, the grating is expected to simultaneously provide a wider TE ER resonance with optimal width.

Independent operation can also be achieved by using different excitation angles for laser (ER) and white light source (BIND). The laser beam or white light source may be directed so that it is incident on the platform at an angle θ. The angle θ may be defined by the expression sin θ=n−λΛ where Λ is a period of the diffractive grooves, λ is the wavelength of the incident light and n is the effective refractive index of the optically transparent layer. See, WO 01/02839.

An apparent advantage of the design of FIGS. 6A-6C is that the ER and BIND structures should operate independently. Hence, structural dimensions optimized for either ER detection or BIND detection alone should work for the combination of the ER and BIND sensor of FIG. 6A-6C. While the specific dimensions for a structure having the unit cell of FIG. 6A-6C is of course variable, in one representative embodiment the BIND grating 504 has a period of between about 260 and about 1500 nm, and the depth of the grating (distance between surfaces 506 and 510) is between 100 nm and about 3000 nm. For the ER grating 502, the period is between about 200 nm and about 1000 nm, and the depth (Z distance between surfaces 506 and 508, and 510 and 512) is between 10 nm and about 300 nm.

The structure of FIG. 6A-6C was simulated on a computer using Rigorous Coupled Wave Analysis (RCWA) and its simulated reflection spectrum obtained, both with and without the addition of an ER grating structure in the X direction. Results of the analysis are disclosed in published PCT application WO 2007/019024 and therefore will not be discussed here for the sake of brevity.

ER technology heretofore employs a resonance mode induced by incident light with a polarisation parallel to the grating, defined here as TE mode or polarisation. Label-free detection technology typically employs a resonance mode induced by incident light with polarisation perpendicular to the grating, defined here as the TM mode or polarisation. This mode produces the narrowest resonance when the sample is suspended in a liquid medium. For a 2D grating, this distinction becomes blurry, and a single peak can be used for both. Also, in theory, the TM peak could be used for ER and the TE peak could be used for BIND. TE mode for ER and TM mode for BIND is one possible embodiment and is not limiting in any way. Above combinations/configurations have the advantages as described, however, other configurations are also in scope of this invention.

During label-free mode detection, biological molecules adhere to the e.g. TiO₂ coating and effectively increase the optical thickness of that material. This results in a shift in the peak wavelength value (PWV) of the resonance. A larger PWV shift for a fixed amount of material represents higher detection sensitivity. When comparing grating designs in a computer simulation, the simulation of additional biological material can be modelled by incrementing the thickness of the e.g. TiO₂ layer rather than adding a hypothetical biological layer. This method has proven effective in other grating design exercises.

The surface of the optically transparent layer (biosensor substrate) may include one or a plurality of corrugated sensing areas which each may carry one or a plurality of capture elements.

A support used in the method of the invention can further comprise a cover layer on the surface of a periodic grating opposite of a substrate layer. Where a cover layer is present, the one or more specific capture elements are immobilized on the surface of the cover layer opposite of the two-dimensional grating. Preferably, a cover layer comprises a material that has a lower refractive index than a material that comprises the two-dimensional grating, so that the ER performance will be minimally reduced. A cover layer can be comprised of, for example, glass (including spin-on glass (SOG)), epoxy, or plastic.

For example, various polymers that meet the refractive index requirement of a biosensor can be used for a cover layer. SOG can be used due to its favourable refractive index, ease of handling, and readiness of being activated with specific capture elements using the wealth of glass surface activation techniques. When the flatness of the biosensor surface is not an issue for a particular system setup, a grating structure of SiN/glass can directly be used as the sensing surface, the activation of which can be done using the same means as on a glass surface.

Resonant reflection can also be obtained without a planarizing cover layer over a two-dimensional grating. Hence, a support can contain only a substrate coated with a structured thin film layer of high refractive index material. Without the use of a planarizing cover layer, the surrounding medium (such as air or water) fills the grating. Therefore, specific capture elements are immobilized to the biosensor on all surfaces a one or two-dimensional grating exposed to the specific capture elements, rather than only on an upper surface.

Each probe/capture element (the terms probes and capture elements are used interchangeably herein) may contain individual and/or mixtures of capture molecules which are capable of affinity reactions. The shape of an individual capture element may be rectangular, circular, ellipsoidal, or any other shape. The area of an individual capture element is between 1 μm² and 10 mm² e.g. between 20 μm² and 1 mm² and preferably between 100 μm² and 1 mm². The capture elements may be arranged in a regular two dimensional array.

The center-to-center (ctc) distance of the capture elements may be between 1 μm and 1 mm, e.g. 5 μm to 1 mm, preferably 10 μm to 1 mm.

The number of capture elements per sensing region is between 1 and 1,000,000, preferably 1 and 100,000. In another aspect, the number of capture elements to be immobilized on the platform may not be limited and may correspond to e.g. the number of genes, DNA sequences, DNA motifs, DNA micro satellites, single nucleotide polymorphisms (SNPs), proteins or cell fragments constituting a genome of a species or organism of interest, or a selection or combination thereof. In a further aspect, the platform of this invention may contain the genomes of two or more species, e.g. mouse and rat.

One or more specific binding substances/probes/capture elements are immobilized on the two-dimensional grating or cover layer, if present, by for example, physical adsorption or by chemical binding. A specific binding substance can be, for example, a nucleic acid, polypeptide, antigen, polyclonal antibody, monoclonal antibody, single chain antibody (scFv), F(ab) fragment, F(ab′) 2 fragment, Fv fragment, small organic molecule, cell, virus, bacteria, or biological sample. A biological sample can be for example, blood, plasma, serum, gastrointestinal secretions, homogenates of tissues or tumours, synovial fluid, faeces, saliva, sputum, cyst fluid, amniotic fluid, cerebrospinal fluid, peritoneal fluid, lung lavage fluid, semen, lymphatic fluid, tears, or prostatic fluid.

Preferably, one or more specific capture elements are arranged in a microarray of distinct locations on a biosensor or transducer. A microarray of specific capture elements comprises one or more specific capture elements on a surface of a biosensor of the invention such that a surface contains many distinct locations, each with a different specific capture element or with a different amount of a specific capture element.

For example, an array can comprise 1, 10, 100, 1,000, 10,000, 100,000, or 1,000,000 distinct locations. Such a biosensor surface is called a microarray because one or more specific capture elements are typically laid out in a regular grid pattern in x-y coordinates. However, a microarray to be used in the method of the invention can comprise one or more specific binding substance laid out in any type of regular or irregular pattern. For example, distinct locations can define a microarray of spots of one or more specific capture elements. A microarray spot can be about 20 to about 500 μm in diameter. A microarray spot can also be about 50 to about 200 μm in diameter. One or more specific capture elements can be bound to their specific binding partners.

A microarray on a support to be used in a method of the invention can be created by placing microdroplets of one or more specific capture elements onto, for example, an x-y grid of locations on a two-dimensional grating or cover layer surface. When the biosensor is exposed to a test sample comprising one or more binding partners, the binding partners will be preferentially attracted to distinct locations on the microarray that comprise specific capture elements that have high affinity for the binding partners. Some of the distinct locations will gather binding partners onto their surface, while other locations will not.

A specific capture element specifically binds to a binding partner that is added to the surface of a support to be used in a method of the invention. A specific capture element specifically binds to its binding partner, but does not substantially bind other binding partners added to the surface of a biosensor. For example, where the specific capture element is an antibody and its binding partner is a particular antigen, the antibody specifically binds to the particular antigen, but does not substantially bind other antigens. A binding partner can be, for example, a nucleic acid, polypeptide, antigen, polyclonal antibody, monoclonal antibody, single chain antibody (scFv), F(ab) fragment, F(ab′) 2 fragment, Fv fragment, small organic molecule, cell, virus, bacteria, and biological sample. A biological sample can be, for example, blood, plasma, serum, gastrointestinal secretions, homogenates of tissues or tumours, synovial fluid, faces, saliva, sputum, cyst fluid, amniotic fluid, cerebrospinal fluid, peritoneal fluid, lung lavage fluid, semen, lymphatic fluid, tears, and prostatic fluid.

One example of a microarray to be used in a method according to the present invention is a nucleic acid microarray, in which each distinct location within the array contains a different nucleic acid molecule. In this embodiment, the spots within the nucleic acid microarray detect complementary chemical binding with an opposing strand of a nucleic acid in a test sample.

The support/platform may include an adhesion promoting layer disposed at the surface of the optically transparent layer in order to enable immobilisation of capture molecules. The adhesion promoting layer may also comprise a microporous layer (ceramics, glass, Si) for further increasing assay and detection efficacy or of gel layers which either can be used as medium for carrying out the capture element immobilisation and sample analysis, thereby further increasing the assay and detection efficacy, or which allow separation of analyte mixtures in the sense of gel electrophoresis. The platform may be formed with a plurality of sensing areas or regions, each having its own diffractive grooves.

In other words, immobilisation of one or more capture elements/probes onto a support/biosensor is performed so that a specific capture element will not be washed away by rinsing procedures, and so that its binding to binding partners in a test sample is unimpeded by the biosensor surface. Several different types of surface chemistry strategies have been implemented for covalent attachment of specific capture elements to, for example, glass for use in various types of microarrays and biosensors. These same methods can be readily adapted to a biosensor of the invention. Surface preparation of a biosensor so that it contains the correct functional groups for binding one or more specific capture element is an integral part of the biosensor manufacturing process.

One or more specific capture elements can hence be attached to a biosensor surface by physical adsorption (i.e., without the use of chemical linkers), by chemical binding (i.e., with the use of chemical linkers) or by electrostatic/coulombic interaction. Chemical binding can generate stronger attachment of specific capture elements on a biosensor surface and provide defined orientation and conformation of the surface-bound molecules. For instance, some types of chemical binding include, for example, amine activation, aldehyde activation, and nickel activation. These surfaces can be used to attach several different types of chemical linkers to a biosensor surface. While an amine surface can be used to attach several types of linker molecules, an aldehyde surface can be used to bind proteins directly, without an additional linker. A nickel surface can be used to bind molecules that have an incorporated histidine (“his”) tag. Detection of “his-tagged” molecules with a nickel-activated surface is well known in the art (Whitesides, Anal. Chem. 68, 490 (1996)).

Immobilisation of specific capture elements to plastic, epoxy, or high refractive index material can be performed essentially as described for immobilisation to glass. However, the acid wash step can be eliminated where such a treatment would damage the material to which the specific capture elements are immobilized.

For the detection of binding partners (analytes in label-free mode) at concentrations less than about 0.1 ng/ml, it is possible to amplify and transduce binding partners bound to a biosensor into an additional layer on the biosensor surface. The increased mass deposited on the biosensor can be easily detected as a consequence of increased optical path length. By incorporating greater mass onto a biosensor surface, the optical density of binding partners on the surface is also increased, thus rendering a greater resonant wavelength shift than would occur without the added mass. The addition of mass can be accomplished, for example, enzymatically, through a “sandwich” assay, or by direct application of mass to the biosensor surface in the form of appropriately conjugated beads or polymers of various size and composition. This principle has been exploited for other types of optical biosensors to demonstrate sensitivity increases over 1500× beyond sensitivity limits achieved without mass amplification. See, e.g., Jenison et al., “Interference-based detection of nucleic acid targets on optically coated silicon,” Nature Biotechnology 19: 62-65 (2001).

As an example, a NH₂-activated biosensor surface can have a specific capture element comprising a single-strand DNA capture probe immobilized on the surface. The capture probe interacts selectively with its complementary target binding partner. The binding partner, in turn, can be designed to include a sequence or tag that will bind a “detector” molecule. A detector molecule can contain, for example, a linker to horseradish peroxidase (HRP) that, when exposed to the correct enzyme, will selectively deposit additional material on the biosensor only where the detector molecule is present. Such a procedure can add, for example, 300 angstroms of detectable biomaterial to the biosensor within a few minutes.

A “sandwich” approach can also be used to enhance detection sensitivity. In this approach, a large molecular weight molecule can be used to amplify the presence of a low molecular weight molecule. For example, a binding partner with a molecular weight of, for example, about 0.1 kDa to about 20 kDa, can be tagged with, for example, succinimidyl-6-[a-methyl-a-(2-pyridyl-dithio) toluamido] hexanoate (SMPT), or dimethylpimelimidate (DMP), histidine, or a biotin molecule. Where the tag is biotin, the biotin molecule will binds strongly with streptavidin, which has a molecular weight of 60 kDa. Because the biotin/streptavidin interaction is highly specific, the streptavidin amplifies the signal that would be produced only by the small binding partner by a factor of 60.

Detection sensitivity can be further enhanced through the use of chemically derivatised small particles. “Nanoparticles” made of colloidal gold, various plastics, or glass with diameters of about 3-300 nm can be coated with molecular species that will enable them to covalently bind selectively to a binding partner. For example, nanoparticles that are covalently coated with streptavidin can be used to enhance the visibility of biotin-tagged binding partners on the biosensor surface. While a streptavidin molecule itself has a molecular weight of 60 kDa, the derivatised bead can have a molecular weight of any size, including, for example, 60 KDa. Binding of a large bead will result in a large change in the optical density upon the biosensor surface, and an easily measurable signal. This method can result in an approximately 1000× enhancement in sensitivity resolution.

A feature of one of the possible biosensor platforms used in the methods of this disclosure is that light energy entering the optically transparent layer is diffracted out of the layer immediately due to the nature of the corrugated platform. Therefore no or negligible waveguiding occurs. Typically the propagation distance is 100 μm or less, preferably 10 μm or less. This is a very surprisingly short distance. The propagation distance is the distance over which the energy of the radiation is reduced to 1/e.

The range of angles suitable for creating a resonance condition is limited by the angle of total reflection for incident light on the platform. Preferred angles are less than 45°, e.g. 30° or less, e.g. 20° to 10° or below, e.g. 0.1° to 9.9°. The angle may equal or approximate normal incidence.

The light generating means may comprise a laser for emitting a coherent laser beam. Other suitable light sources include discharge lamps or low pressure lamps, e.g. Hg or Xe, where the emitted spectral lines have sufficient coherence length, and light-emitting diodes (LED). The apparatus may also include optical elements for directing the laser beam so that it is incident on the platform at an angle θ, and elements for shaping the plane of polarisation of the coherent beam, e.g. adapted to transmit linearly polarised light. The angle θ may be defined by the expression sin θ=n−λ/Λ where Λ is a period of the diffractive grooves, λ is the wavelength of the incident light and n is the effective refractive index of the optically transparent layer.

Examples of lasers that may be used are gas lasers, solid state lasers, dye lasers, semiconductor lasers. If necessary, the emission wavelength can be doubled by means of nonlinear optical elements. Especially suitable lasers are argon ion lasers, krypton ion lasers, argon/krypton ion lasers, and helium/neon lasers which emit at wavelengths between 275 and 753 nm. Very suitable are diode lasers or frequency doubled diode lasers of semiconductor material which have small dimensions and low power consumption.

Another appropriate type of excitation makes use of VCSEL's (vertical cavity surface emitting lasers) which may individually excite the recognition elements on the platform.

In one embodiment, a support to be used in a method of the invention will be illuminated with white light that will contain light of every polarisation angle. The orientation of the polarisation angle with respect to repeating features in a biosensor grating will determine the resonance wavelength. For example, a “linear grating” biosensor structure consisting of a set of repeating lines and spaces will have two optical polarisations that can generate separate resonant reflections. Light that is polarized perpendicularly to the lines is called “s-polarized,” while light that is polarized parallel to the lines is called “p-polarized.” Both the s and p components of incident light exist simultaneously in an unfiltered illumination beam, and each generates a separate resonant signal. A support structure can generally be designed to optimize the properties of only one polarisation (the s-polarisation), and the non-optimized polarisation is easily removed by a polarizing filter.

In order to remove the polarisation dependence, so that every polarisation angle generates the same resonant reflection spectra, an alternate structure can be used that consists of a set of concentric rings. In this structure, the difference between the inside diameter and the outside diameter of each concentric ring is equal to about one-half of a grating period. Each successive ring has an inside diameter that is about one grating period greater than the inside diameter of the previous ring. The concentric ring pattern extends to cover a single sensor location—such as a microarray spot or a microtitre plate well. Each separate microarray spot or microtitre plate well has a separate concentric ring pattern centred within it. All polarisation directions of such a structure have the same cross-sectional profile. The concentric ring structure must be illuminated precisely on-centre to preserve polarisation independence. The grating period of a concentric ring structure is less than the wavelength of the resonantly reflected light. The grating period is about 0.01 micron to about 1 micron. The grating depth is about 0.01 to about 1 micron.

In another embodiment, an array of holes or posts are arranged to closely approximate the concentric circle structure described above without requiring the illumination beam to be centred upon any particular location of the grid. Such an array pattern is automatically generated by the optical interference of three laser beams incident on a surface from three directions at equal angles. In this pattern, the holes (or posts) are centred upon the corners of an array of closely packed hexagons. The holes or posts also occur in the centre of each hexagon. Such a hexagonal grid of holes or posts has three polarisation directions that “see” the same cross-sectional profile. The hexagonal grid structure, therefore, provides equivalent resonant reflection spectra using light of any polarisation angle. Thus, no polarizing filter is required to remove unwanted reflected signal components. The period of the holes or posts can be about 0.01 μm to about 1 μm and the depth or height can be about 0.01 μm to about 1 μm.

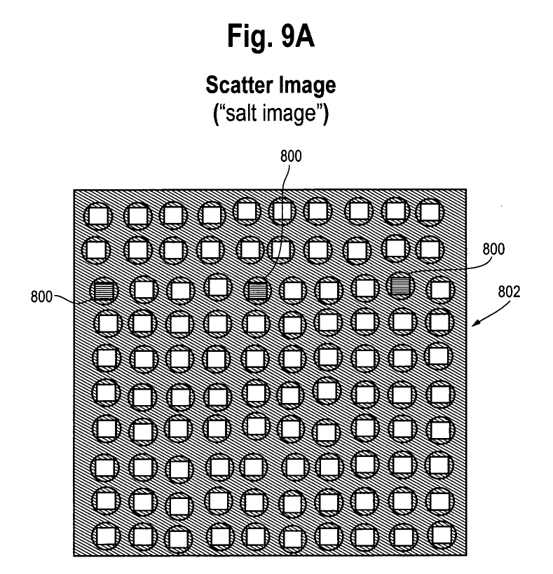

The detecting system (see FIG. 7 below for one example) may be arranged to detect luminescence such as fluorescence. Affinity partners can be labelled in such a way that Förster fluorescence energy transfer (FRET) can occur upon binding of analyte molecules to capture molecules. The maximum of the luminescence intensity might be slightly shifted relative to the position of highest anormal reflection depending on the refractive index values of the layer system and the corresponding Fresnel Coefficients.

The samples may be used either undiluted or with added solvents. Suitable solvents include water, aqueous buffer solutions, protein solutions, natural or artificial oligomer or polymer solutions, and organic solvents. Suitable organic solvents include alcohols, ketones, esters, aliphatic hydrocarbons, aldehydes, acetonitrile or nitrites.

Solubilisers or additives may be included, and may be organic or inorganic compounds or biochemical reagents such as diethylpyrocarbonate, phenol, formamide, SSC (sodium citrate/sodium chloride), SDS (sodium dodecylsulfate), buffer reagents, enzymes, reverse transcriptase, RNAase, organic or inorganic polymers.

The sample may also comprise constituents that are not soluble in the solvents used, such as pigment particles, dispersants and natural and synthetic oligomers or polymers.

Luminescent labels can be used to modify capture elements, assayed molecules in the analyte, or any other species, e.g. endogeneous/exogeneous controls, spacer molecules, primers, bio/materials, which interact with the sensor surface.

The luminescence dyes used as markers may be chemically or physically, for instance electrostatically, bonded to one or multiple affinity binding partners (or derivatives thereof) present in the analyte solution and/or attached to the platform. In case of naturally-occurring oligomers or polymers such as DNA, RNA, saccharides, proteins, or peptides, as well as synthetic oligomers or polymers, involved in the affinity reaction, intercalating dyes are also suitable. Luminophores may be attached to affinity partners present in the analyte solution via biological interaction such as biotin/avidin binding or metal complex formation such as His-tag coupling.

One or multiple luminescence markers may be attached to affinity partners present in the analyte solution, to capture elements immobilized on the platform, or both to affinity partners present in analyte solution and capture elements immobilized at the platform, in order to quantitatively determine the presence of one or multiple affinity binding partners.

The spectroscopic properties of the luminescence markers may be chosen to match the conditions Förster Energy Transfer or Photoinduced Electron Transfer. Distance and concentration dependent luminescence of acceptors and donors may then be used for the quantification of analyte molecules.

Quantification of affinity binding partners may be based on intermolecular and/or intramolecular interaction between such donors and acceptors bound to molecules involved in affinity reactions. Intramolecular assemblies of luminescence donors and acceptors covalently linked to affinity binding partners, Molecular Beacons (S. Tyagi et al., Nature Biotechnology) which change the distance between donor and acceptor upon affinity reaction, may also be used as capture molecules or additives for the analyte solution. In addition, pH and potentially sensitive luminophores or luminophores sensitive to enzyme activity may be used, such as enzyme mediated formation of fluorescing derivatives.

Transfluorospheres or derivatives thereof may be used for fluorescence labelling, and chemiluminescent or electroluminescent molecules may be used as markers.

Luminescent compounds having luminescence in the range of from 400 nm to 1200 nm which are functionalised or modified in order to be attached to one or more of the affinity partners, such as derivatives of:
polyphenyl and heteroaromatic compounds
stilbenes,
coumarines,
xanthene dyes,
methine dyes,
oxazine dyes,
rhodamines,
fluoresceins,
coumarins, stilbenes,
pyrenes, perylenes,
cyanines, oxacyanines, phthalocyanines, porphyrins, naphthalopcyanins, azobenzene derivatives, distyryl biphenyls,
transition metal complexes e.g. polypyridyl/ruthenium complexes, tris (2,2′ bipyridyl) ruthenium chloride, tris(1,10-phenanthroline) ruthenium chloride, tris (4,7 diphenyl-1,10-phenanthroline) ruthenium chloride and polypyridyl/phenazine/ruthenium complexes, such as octaethyl-platinum-porphyrin, Europium and Terbium complexes may be used as luminescence markers
nanoparticles, microparticles
any other light emitting species that can be excited by evanescent fields.

Suitable for analysis of blood or serum are dyes having absorption and emission wavelength in the range from 400 nm to 1000 nm. Furthermore luminophores suitable for two and three photon excitation can be used.

Dyes which are suitable in this invention may contain functional groups for covalent bonding, e.g. fluorescein derivatives such as fluorescein isothiocyanate or NH₂ esters. Also suitable are the functional fluorescent dyes commercially available from Amersham Life Science, Inc., Texas, and Molecular Probes Inc. Other suitable dyes include dyes modified with deoxynucleotide triphosphate (dNTP) which can be enzymatically incorporated into RNA or DNA strands.

Further suitable dyes include Quantum Dot Particles or Beads (Invitrogen Corporation, Carlsbad Calif.) or derivatives thereof or derivatives of transition metal complexes which may be excited at one and the same defined wavelength, and derivatives show luminescence emission at distinguishable wavelengths.

Analytes may be detected either via directly bonded luminescence markers, or indirectly by competition with added luminescence marked species, or by concentration-, distance-, pH-, potential- or redox potential-dependent interaction of luminescence donors and luminescence/electron acceptors used as markers bonded to one and/or multiple analyte species and/or capture elements. The luminescence of the donor and/or the luminescence of the quencher can be measured for the quantification of the analytes.

In the same manner affinity partners can be labelled in such a way that electron transfer or photoinduced electron transfer leads to quenching of fluorescence upon binding of analyte molecules to capture molecules.

Appropriate detectors for luminescence include CCD-cameras, photomultiplier tubes, avalanche photodiodes, photodiodes, hybrid photomultiplier tubes, or arrays thereof. Detection can also be performed in the absence of a label as described in U.S. patent application publications U.S. 2003/0027327; 2002/0127565, 2003/0059855 and 2003/0032039, or the U.S. Pat. No. 7,023,544, which are hereby incorporated herein by reference. The detection means can be arranged to detect in addition changes in refractive index. The incident beam may be arranged to illuminate the sensing area or all sensing areas on one common platform. Alternatively the beam can be arranged to illuminate only a small sub-area of the sensing area to be analysed and the beam and/or the platform may be arranged so that they can undergo relative movement in order to scan the sensing area of the platform.

Accordingly, the detecting means may be arranged in an appropriate way to acquire the luminescence signal intensities of the entire sensing area in a single exposure step. Alternatively the detection and/or excitation means may be arranged in order to scan the sensing areas stepwise.

The capture or recognition elements which can be deposited onto the platform are many and varied. Generally speaking the capture molecules used should be capable of affinity reactions. Examples of recognition or capture molecules which can be used with the present platform are as follows:
nucleotides, oligonucleotides (and chemical derivatives thereof)
DNA (double strand or single strand) a) linear (and chemical derivatives thereof) b) circular (e.g. plasmids, cosmids, BACs, ACs)
total RNA, messenger RNA, cRNA, mitochondrial RNA, artificial RNA, aptamers PNA (peptidenucleic acids)
Polyclonal, Monoclonal, recombinant, engineered antibodies, antigens, haptens, antibody FAB subunits (modified if necessary)
proteins, modified proteins, enzymes, enzyme cofactors or inhibitors, protein complexes, lectins, histidine-labelled proteins, chelators for histidine-tag components (HIS-tag), tagged proteins, artificial antibodies, molecular imprints, plastibodies membrane receptors, whole cells, cell fragments and cellular substructures, synapses, agonists/antagonists, cells, cell organelles, e.g. microsomes small molecules such as benzodiazapines,
prostaglandins,
antibiotics, drugs, metabolites, drug metabolites
natural products
carbohydrates and derivatives
natural and artificial ligands
steroids, hormones
peptides
native or artificial polymers
molecular probes
natural and artificial receptors and chemical derivatives thereof
chelating reagents, crown ether, ligands, supramolecular assemblies
indicators (pH, potential, membrane potential, redox potential)
tissue samples (tissue micro arrays)

The activity or density of the capture molecules can be optimised in a number of ways well known in the art.

Periodic structures can also be obtained by attaching nanoparticles to a surface, wherein said nanoparticles are of similar size and act as a periodical structure that allow optical coupling/resonance.

Several detection systems 300 for obtaining both BIND and ER data from a grating-based biosensor are described in published PCT application WO 2007/019024. One of them is illustrated in FIG. 7. The system 300 of FIG. 7 is an imaging readout system. The biosensor 100 is designed to exhibit both a sharp resonant peak, in the optical spectrum, for label-free detection and a high electromagnetic field in the evanescent region of the biosensor for significant enhancement of fluorescence signal. The readout system reads out both of these effects, taking advantage of these biosensor properties. This readout system has the capability to measure either or both signals from the biosensor.

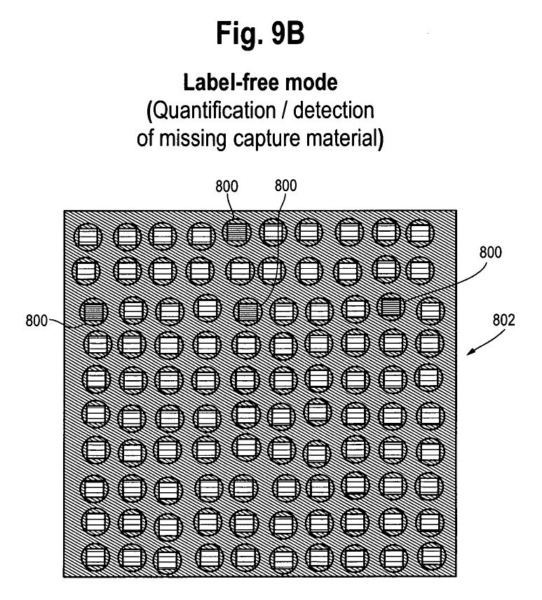

The ER+BIND biosensor 100, referred to herein as a “comBIND sensor” herein, is interrogated optically from the bottom side of the sensor. On the topside of the biosensor 100, the biosensor may be immersed in water or another liquid, or it may be exposed to air. Any molecular or cellular binding interaction, which the biosensor is designed to detect, takes place on the topside of the biosensor 100. The biosensor 100 may be part of a larger assay device that includes liquid containing vessels, such as for example a microwell plate having e.g., 8 columns of wells, each row containing 12 wells. The biosensor may also be a component of a microarray slide (see FIG. 8). In the illustration of FIG. 7, a single well (detection region) 302 is shown in cross-section, it being understood that dozens, hundreds or even thousands of such detection regions may be present.

The imaging readout and detection system 300 includes an ER light source 340 in the form of a laser (e.g., HeNe laser), a broader spectrum BIND light source 350 including as a halogen white light source or a LED 352, and a CCD camera system 338 serving as a common detector to capture both ER and label-free data in successive images. The system 300 includes an optical beam combining subsystem that includes dichroic mirrors 364 and 330 which serves to combine and direct incident light 372 from the light sources 340 and 352 onto the biosensor. The dichroic mirror 330 collects signal light for detection and directs it to a lens 336 where it is imaged by the CCD camera 338.

The light beam 370 present below the biosensor 100 consists of illumination light 372 and reflected light 374. The reflected light 374 includes direct reflection and fluorescent emission if there is fluorescent material present on the biosensor.

Signal detected by the CCD camera 338 through a lens system 336 is processed electronically or by computer algorithm to become BIND (label-free) data 380 or ER data 382. Such data may be stored, displayed, and analyzed on an analytical instrument such as a computer or workstation for the instrumentation shown in FIG. 7 (not shown, but having access to data 382 and 380) by the user of the readout system 300. Furthermore, the combination of the BIND data 380 and the ER data 382 allows the user to gain information on binding interactions or cell interactions that is unique to the novel biosensor 100.

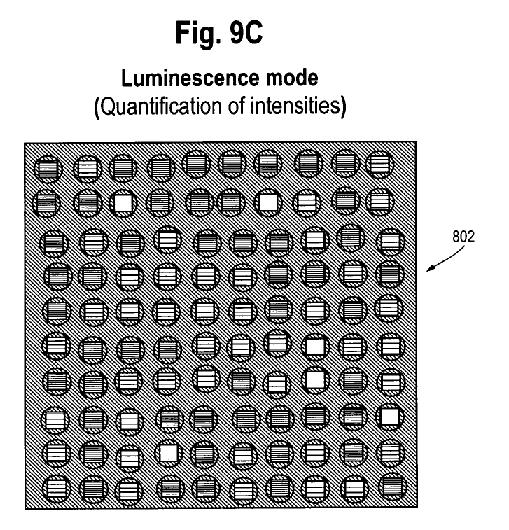

In the illustrated design, the optical components 340, 350 and 330 are designed to produce a single beam 372 of incident radiation and the biosensor is moved in X and Y directions to thereby sequentially obtain data from all the wells 302 or binding sites on the biosensor 100 surface. Such motion may be produced by placing the biosensor 100 on an X-Y motion stage (not shown), of which persons skilled in the art are familiar. When a given well or binding site 302 is in position such that the well 302 is in registry with the beam 372, in one embodiment the light sources 340 and 350 are operated in succession (or selectively allowed to direct radiation onto the biosensor) and first and second images are captured by the CCD camera 338, one an ER image and the other a BIND image. The successive collection of CCD images could be facilitated by use of the beam selection mechanism 360 (such as a shutter), which selectively allows light from either the source 340 or the source 350 to pass to the dichroic mirror 330 and be reflected onto the biosensor. Beam selection can also be done electronically, such as by electronically controlling the on and off times of the light sources 340 and 350. Alternatively, both light sources could be activated at the same time and the selection mechanism 360 operated to pass both beams so that the incident beam 372 contains light from both sources. In this situation, the CCD camera 338 would capture a single image containing both ER and BIND information. Image processing techniques would then be applied to the resultant image from the CCD camera 338 to extract the BIND and ER components of the composite image. The shift in peak resonance wavelength measured by the detection system is determined on a pixel-by-pixel basis and the magnitude of such shifts is converted either to colors or to relative brightness, or both, for purposes of rendering the label-free image such as shown in FIG. 9B.

The ER light source 340 may be a laser, such as a helium-neon (HeNe) laser. The laser beam 341 further goes through a beam-conditioning device 342 such as a beam expander. The beam expander 342 expands a small diameter laser beam into a large diameter laser beam. The output beam 343 is collimated and linearly polarized. The biosensor produces the ER effect in response to incident light at a specific polarization. Polarization may be achieved by using a laser designed for producing a linearly polarized output laser beam.

The BIND (label-free) light source 350 may consist of a halogen or LED light source 352, and a monochromator 354 with a wavelength adjustment mechanism 356. The light beam 353 emitted by the light source 352 is broadband in nature, while the light beam 355 at the exit port of the monochromator 354 is monochromatic.

The output light beam 355 from the monochromator 354 is conditioned by a beam conditioning device 358, which may be a collimator. A mirror 365 directs the light beam 349 from the output of the conditioning device 358 to the dichroic mirror 364. The combined light from the light sources 340 and 350 is shown at 366 where it is directed to the beam splitting and combining assembly 330 which then directs it to the bottom surface of the biosensor 100.

The BIND light source 350 may also consist of a tuneable laser. In that case, the beam-conditioning device 358 is a beam expander. Note also that a tuneable laser or flash lamp could serve as a single illumination source for both BIND and ER measurements.

In addition, since polarized light facilitates detection of a BIND signal, there may be a polarizer within the light source 352 so that the light 363 is linearly polarized. Alternatively, the light-directing element 365 may be a polarizing beam splitter to transform a randomly polarized light 359 into a linearly polarized light 363.

For detection of the laser excited fluorescence signal, the beam splitting and combining assembly 330 incorporates a set of optical filters 332 and 334. Filter 332 is a dichroic filter that reflects the laser light while transmitting fluoresced light from the sample. Filter 332 also functions as a beamsplitter in the BIND wavelength range, which is 830 nm to 900 nm in one preferred design. Filter 334 only allows transmission of light within two wavelength ranges: laser excited fluorescence and the BIND wavelength range. An imaging lens 336 may be used to collect the fluorescence light at the biosensor surface and focus it on the focal plane of the CCD camera 338.

The design of FIG. 7 also includes rotation apparatus to rotate the biosensor relative to the incident beam 372 for purposes of ER detection. In one possible embodiment, a rotation device 331 is attached to the beam splitting and combining assembly 330 and rotates the assembly 330 as indicated by the arrows (thereby providing for rotation of the incident beam about angle θ). In an alternative embodiment, rotation device 331 is omitted and instead a rotational device 333 is attached to the XY motion stage which operates to rotate the XY motion stage (and biosensor 100 mounted thereon) relative to the (fixed) incident beam 372, as indicated by the arrows to the left of device 333 in FIG. 26.

Additional lenses, mirrors and optical filters may be incorporated into the readout system to achieve desired performance. Properly designed optical filters may be used to eliminate undesired cross-talk between BIND detection and ER detection. In addition, a beam selection mechanism in the form of electronic or mechanical shutters 360 may be used to properly synchronize light illumination and detection of the two channels, so that only one light source illuminates the biosensor at a given time, to eliminate any cross-talk.

A significant advantage of the biosensor readout system described in FIG. 7 is that both BIND and ER data may be collectedly simultaneously (or in rapid succession) at the same biosensor location. High-resolution imaging methods are useful for high content bioassays such as cell-based assays or microarrays.

An integrating single point detector may replace the CCD camera 338. In that case, the system produces an image by synchronizing sensor motion, over the location of the incident radiation 372, with the detector output.

Further details on use of a CCD camera to obtain ER data from a biosensor can be found in the technical literature, e.g., an article of Dieter Neuschäfer, Wolfgang Budach, et al., Biosensors & Bioelectronics, Vol. 18 (2003) p. 489-497, the contents of which are incorporated by reference herein.

The following description and examples of calibration and normalization methods for biosensors are merely illustrative of the present disclosure and are not limiting.

### EXAMPLES

Details on the ER slides (“NovaChip”) have been published in e.g. D. Neuschäfer et al., Biosensors and Bioelectronics, 18: 489-497 (2003), or W. Budach et al., Analytical Chemistry, 75: 2571-2577 (2003). The approach takes advantage of a phenomenon that has been attributed as abnormal reflection, see e.g. S. S. Wang & R. Magnusson, Applied Optics, 32(14): 2606-2613 (1993), or O. Parriaux et al., Pure & Applied Optics, 5: 453-469 (1996). Excitation photons incident on the chip under resonance conditions couple into a thin corrugated metal oxide surface at the site of incidence. As a result of the transducer geometry, the energy is locally confined into the thin corrugated layer of high refractive index material. Consequently, strong electromagnetic fields are generated at the surface of the chip. The effect has been attributed as evanescent resonance and leads to increased fluorescence intensity of chromophores close to the surface. The effective field strength can be increased up to 100-fold by the confinement of the available excitation energy, depending on the optical properties of the used optical detection system. The NovaChips used for the experiments described in the examples have a resonance angle of 2° with respect to normal for TE polarized light of 633 nm wavelength. The observed increase of fluorescence signal/noise ratio with the used Tecan microarray laser scanner was about 10-20 fold compared to glass slides processed under identical conditions.

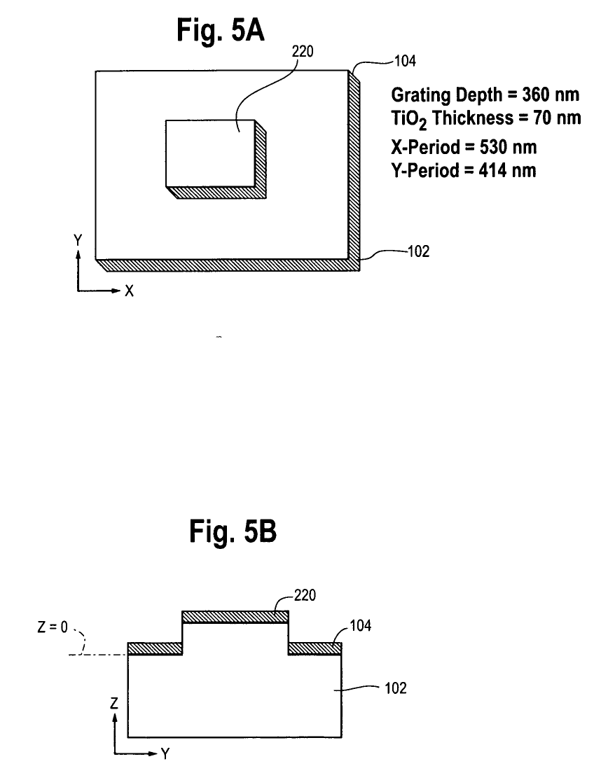

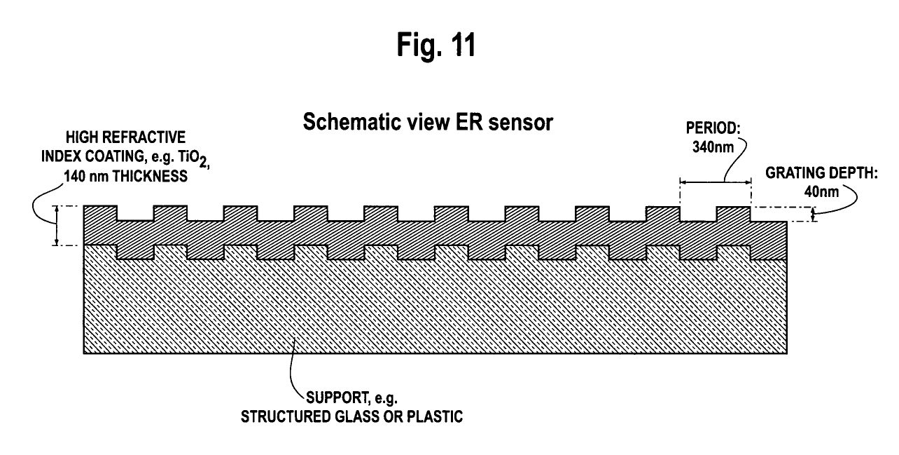

FIG. 8 is a photograph of a biosensor captured by the CCD camera of FIG. 7, the biosensor having the grating structure of FIG. 11 in the form of a microarray having a multiplicity of capture element locations, the locations clustered in groups of regions as indicated in FIG. 3.

FIGS. 9A-9C shows three different images of the spot or capture element regions of the biosensor of FIG. 8, in which individual capture element locations are visualized with a circle in FIGS. 9A, 9B, and 9C.

FIG. 9A is a “salt image” of one of the regions of FIG. 8 which shows the printed spots or locations that are expected to consist of capture elements (e.g. oligonucleotide) and print buffer. The actual morphology of the spot locations in the image is varying and depends on the process conditions. The image provides only qualitative information, e.g. spots where capture materials have not been printed/deposited correctly in the chip surface. This information can be used as basic quality flags for each of the capture elements.

FIG. 9B is a label-free image of the region of FIG. 9A, obtained after a washing step that removes the excess material from the biosensor surface. The intensity of the individual locations corresponds to the amount of immobilized material of the oligonucleotides which are immobilized/deposited in the individual locations on the microarray. The intensity measurements (“BIND” data) are made using the system of either FIG. 3 or 7, or possibly a different system including one with a spectrometer as disclosed in PCT application WO 2007/019024.

FIG. 9C is an image obtained with the system of FIG. 7 in an ER mode showing the intensity of the regions corresponds to the abundance of a particular mRNA in the hybridised sample.

Preparation of Microarrays

The microarrays (one of which shown in FIG. 8) were cleaned and prepared as described in e.g. W. Budach et al., Analytical Chemistry, 75: 2571-2577 (2003), and the AROS Human v3 oligonucleotide, 70-mers, set from Operon Inc. was arrayed with a Microgrid printer at 23° C. and 55-60% relative humidity (approx. 37 k features/1 replicates each, print buffer 4×SSC/0.001% Sarcosyl). Slides were stored sealed until use.

Buffers

Wash Buffer: 50 mM NaCl, 20 mM Na-phosphate buffer pH 6.5, 1 mM EDTA, 0.1% (w/v) SDS

Hybridisation Buffer: Express Hyb. Buffer (BD #8015-1)/Formamide (Fluka #47671) 70/30 v:v, 100 μg/ml salmon sperm

Microarray Quality Control

1. Scatter Images, “Salt” Images, Qualification

Subsequently, the microarrays were scanned with a Tecan laser scanner (gain 120) using a 633 nm laser (red) as a light source. The optical filter of the detection unit was removed to allow collection of scattered light images, i.e. images of laser light directly scattered from the physical profile of the spots composed in large part of salt from the spotting buffer. These images are therefore also termed “Salt” images. FIG. 9A shows a close-up of the microarray used for this application example. The images allow a coarse first assessment of the microarray quality, as analysis of this image allows identification of missing spots, particles or artifacts.

2. Label-Free Mode, Quantification

The microarray was then washed to remove unbound oligonucleotides and spotting buffer salt from. Bound oligonucleotides remain attached to reactive groups on the surface. The wash process consisted of 20 seconds in a stirrer-containing recipient with Wash Buffer followed by 20 seconds in a second recipient containing Wash Buffer diluted 1:3 with deionised water. Subsequently, the slides were dried in a nitrogen stream.

After washing, a 16 Bit TIF label free image of the remaining oligonucleotide material was obtained using a BIND TM Scanner from SRU Biosystems Inc. The label free scan images the spectral shift of the TM resonance at 15 um/pixel resolution. FIG. 9B shows the area of the label free image that corresponds to the “salt” image of FIG. 9A.

Label Free Scanner Principle of Operation

The label free scanner system includes a light source and optical elements that direct collimated white light towards the surface of the sensor. An imaging spectrometer receives light reflected from the sensor and generates an image where one axis represents a spatial line scan and the second axis reports the reflected spectrum at each pixel on the line scan. Software determines the spectral location of the TM resonance, referred to as Peak Wavelength Value (PWV), within the reflected spectrum. The line scan traversed the slide progressively constructing a PWV image. Pixels corresponding to oligonucleotide spots have higher PWV than areas without bound material. The label free signal consists of the PWV difference (shift) between pixels corresponding to spots and surrounding (background) pixels. Alternatively or in addition to this analysis, one can acquire a baseline PWV scan prior to spotting and subtract the baseline PWV values from a post spotted image. The shifts in PWV are converted to color or intensity for purposes of rendering an image such as shown in FIG. 9B.

Sample/RNA Processing

Commercial human reference RNA (Stratagene) was labelled per the protocol and materials of the Ambion labelling kit (#1753). This experiment used 100 ng of labelled RNA.

Microarray Hybridisation and Scanning of Luminescence/Fluorescence Images

A Tecan HS 4800 Hybridisation station from Tecan, Inc. performed the prewash, hybridisation, and postwash of the microarrays. Prewash consisted of 3 cycles with Wash Buffer at RT/75° C./50° C. (each 20 sec) followed by an additional 10 sec wash with Hybridisation Buffer at 50° C. A 100 μL sample of 100 ng concentration labelled RNA in Hybridisation Buffer was then injected into the flow chamber at 50° C. and agitated for 1 minute. After 10 min. at 75° C., the temperature was maintained at 42° C. for 16 hours with agitation. The postwash consisted of 4 cycles with Wash Buffer at 42° C. followed by an additional wash at 23° C. (each 20 sec). Finally, the slides were washed 3 times with diluted Wash Buffer at RT, dried in N₂ stream, and scanned immediately with a Tecan fluorescence laser scanner (gain 80%). Images were stored as 16 Bit TIF files. FIG. 9c shows the reference area of the fluorescence mode image that corresponds to the previously discussed “salt” (FIG. 9A) and label-free (FIG. 9B) images.

Image Processing and Quality Control

The spots or capture element regions, are circumscribed graphically by the analysis software (ArrayPro) in FIGS. 9A, 9B and 9C.

In FIG. 9A, the scatter mode, “salt image”, images printed spots expected to result in oligonucleotide capture elements after washing. Actual spot morphology varies depending on process conditions. The image provides only qualitative information regarding the presence and quality of an individual capture element, e.g. whether the printing process deposited material at the specified location. This information can serve as a flag for gross printing errors.

In FIG. 9B, the label-free mode image, is obtained after a washing step that removes excess (unbound) material from the spotted areas. The intensity of the label free signal in the individual capture areas corresponds to the amount of immobilized material (oligonucleotide). Thus, this signal provides a quantitative value for the amount of probe material available for binding in the subsequent hybridisation step.

In FIG. 9C, the ER/fluorescence mode image, the signal intensity of each capture area (spot) corresponds to the abundance of labelled mRNA bound to the probe material in that area.

The images obtained in label-free and luminescence/fluorescence mode were analyzed by means of Array Pro (Mediacybernetics, Inc. US). A sub section of 10 Rows (R)×10 Columns (C) was used for the present example (same section for all images to allow comparison and calibration). The three TABLES 1a, 1b, and 1c below quantify data from Row 1 of the 10×10 spot array depicted in images FIGS. 9A, 9B and 9C. The TABLES derive “Net” intensity by subtracting the mean of a local “Background” ring surrounding each spot from the interior mean (“Raw” signal) of each spot.

TABLE 1a
Data for the first 10 spots/genes in the scatter image

| Row | Column | Background | Raw intensity | Net intensity |
|---|---|---|---|---|
| 1 | 1 | 174 | 881 | 707 |
| 1 | 2 | 113 | 1384 | 1271 |
| 1 | 3 | 116 | 1247 | 1131 |
| 1 | 4 | 110 | 701 | 591 |
| 1 | 5 | 107 | 2997 | 2889 |
| 1 | 6 | 132 | 2264 | 2132 |
| 1 | 7 | 110 | 1478 | 1368 |
| 1 | 8 | 112 | 1191 | 1079 |
| 1 | 9 | 113 | 1743 | 1630 |
| 1 | 10 | 108 | 2001 | 1893 |

TABLE 1a quantifies data obtained in by analysing the intensity of the first 10 spots/genes (R=1, C=1 to 10) in the scatter or “salt” image. Definition of an intensity threshold (or more sophisticated rules, algorithms, in general) allows identification of incorrectly deposited spots. See also in Table 2, where the scatter mode intensity threshold is used into flag those spots/capture elements that appear missing. This procedure can be automated and allows a first assessment of the quality of a microarray production batch.

TABLE 1b reports data obtained in label-free mode for the first 10 spots/genes (R=1, C=1 to 10). Again, the definition of a threshold (or more sophisticated rules, algorithms, in general) allows identification of incorrectly printed spots. In addition, the label free Net intensity provides a calibration of the deposited material.

TABLE 1b
Data in label-free mode for the first 10 spots/genes
(R = 1, C = 1 to 10)

| Row | Column | Background | Raw intensity | Net intensity |
|---|---|---|---|---|
| 1 | 1 | 13565 | 17680 | 4116 |
| 1 | 2 | 14393 | 18111 | 3718 |
| 1 | 3 | 14673 | 17789 | 3116 |
| 1 | 4 | 13268 | 18966 | 5698 |
| 1 | 5 | 13919 | 14164 | 245 |
| 1 | 6 | 13740 | 19423 | 5683 |
| 1 | 7 | 14093 | 21452 | 7359 |
| 1 | 8 | 14243 | 18267 | 4025 |
| 1 | 9 | 14094 | 17194 | 3100 |
| 1 | 10 | 14804 | 18883 | 4078 |

For example, the first Oligonucleotide I (Row=1, Column=1), Oligonucleotide (1,1), has a Net Signal of 4116 counts. Oligonucleotide (1,7) has an intensity of 7359 counts, which indicates that more material has been immobilized. These values, yielding relative probe density, at each spot, provide the basis for normalizing subsequent fluorescent mode signal. Oligonucleotide (1,5) has a very low Net signal of 245 counts, which can be interpreted as a missing spot, i.e. the location does not contain enough probe material to provide reliable data.

Automation of this procedure provides a rapid and detailed assessment of the quality of a microarray print batch as well as quantification of the density of printed genes immobilized within individual capture elements.

TABLE 1c shows the corresponding fluorescence data for the same set of oligonucleotides. The fluorescence signal responds to the frequency of gene binding events during hybridisation. Both the density of printed probe genes and the frequency of gene commonality between the probe and analyte determine the frequency of gene binding and hence, both factors affect fluorescent signal. For example, a low fluorescence signal could result from a missing spot or negligible gene expression in the target sample.

TABLE 1c
Corresponding luminescence/fluorescence
data of the same set of oligonucleotides

| Row | Column | Background | Raw intensity | Net intensity |
|---|---|---|---|---|
| 1 | 1 | 46 | 637 | 592 |
| 1 | 2 | 45 | 56 | 10 |
| 1 | 3 | 46 | 51 | 5 |
| 1 | 4 | 45 | 51 | 7 |
| 1 | 5 | 45 | 46 | 1 |
| 1 | 6 | 45 | 50 | 5 |
| 1 | 7 | 44 | 54 | 10 |
| 1 | 8 | 46 | 50 | 3 |
| 1 | 9 | 46 | 50 | 5 |
| 1 | 10 | 47 | 63 | 16 |

Table 2 combines all three data sets.

TABLE 2
Data sets combined for calibration of individual oligonucleotides

| | | | | | | Luminescence mode | | |
|---|---|---|---|---|---|---|---|---|
| | | Scatter | | Label-free mode | | | Net | |
| [all data a.u.] | | | QC Threshold | | QC Threshold | Net intensity | Intensity | |
| Row | Column | Net intensity | reached ? | net intensity | reached ? | not calibrated | calibrated | Deposition |
| 1 | 1 | 707 | 1 | 4116 | 1 | 592 | 719 | OK |
| 1 | 2 | 1271 | 1 | 3718 | 1 | 10 | 14 | OK |
| 1 | 3 | 1131 | 1 | 3116 | 1 | 5 | 8 | OK |
| 1 | 4 | 591 | 1 | 5698 | 1 | 7 | 6 | OK |
| 1 | 5 | 2889 | 1 | 245 | 0 | 1 | Missing | Missing |
| 1 | 6 | 2132 | 1 | 5683 | 1 | 5 | 5 | OK |
| 1 | 7 | 1368 | 1 | 7359 | 1 | 10 | 7 | OK |
| 1 | 8 | 1079 | 1 | 4025 | 1 | 3 | 4 | OK |
| 1 | 9 | 1630 | 1 | 3100 | 1 | 5 | 8 | OK |
| 1 | 10 | 1893 | 1 | 4078 | 1 | 16 | 20 | OK |
| 2 | 1 | 1761 | 1 | 5136 | 1 | 6 | 6 | OK |
| 2 | 2 | 1171 | 1 | 4205 | 1 | 8 | 10 | OK |
| 2 | 3 | 747 | 1 | 5646 | 1 | 149 | 132 | OK |
| 2 | 4 | 1427 | 1 | 3868 | 1 | 6 | 8 | OK |
| 2 | 5 | 851 | 1 | 3565 | 1 | 4 | 6 | OK |
| 2 | 6 | 746 | 1 | 2761 | 1 | 3 | 6 | OK |
| 2 | 7 | 806 | 1 | 4916 | 1 | 525 | 534 | OK |
| 2 | 8 | 936 | 1 | 3580 | 1 | 119 | 167 | OK |
| 2 | 9 | 862 | 1 | 2578 | 1 | 1 | 2 | OK |
| 2 | 10 | 1289 | 1 | 3531 | 1 | 8 | 12 | OK |
| 3 | 1 | 31 | 0 | 86 | 0 | 2 | Missing | Missing |
| 3 | 2 | 875 | 1 | 4612 | 1 | 18 | 19 | OK |
| 3 | 3 | 1491 | 1 | 3866 | 1 | 3 | 4 | OK |

Applying a threshold to the Scatter net intensities column in the table above flags exceptionally weak or missing spots. Net intensities from the label free scan provide quantifiable information regarding the amount of immobilized capture element at each position. For example, oligonucleotides (1,5) and (3,1) have very low values. Again, the definition of a threshold allows flagging of missing spots. Furthermore, normalization of fluorescent signal by the label free intensities can compensate for variations of the amount of immobilized material. The third section of Table 2 accomplishes this normalization process.

Application of the following Normalization Equation normalizes the fluorescence (also termed luminescence) signal (LNI_{calibrated}) to the amount of probe material as determined by the label free scan:

LNI_{calibrated}=LNI_{nc}*Scaling Value/LFNI, Equation (1)

where LNI_{nc} represents the non-calibrated fluorescence signal and LFNI represents the label free net intensity. A scaling or target label free value of 5000 cts maintains the fluorescent signal count range. Calibrated values reduce variability in the assessment of gene expression level by decreasing/compensating for the influence of spot printing variability. Though not shown in this example, a “salt” image may indicate successful deposition of buffer solution but not result in the immobilization of actual probe material, either through an error in buffer composition or process artifact. The label free signal reports actual probe immobilization level immediately prior (in this example) to the labelled analyte binding event.

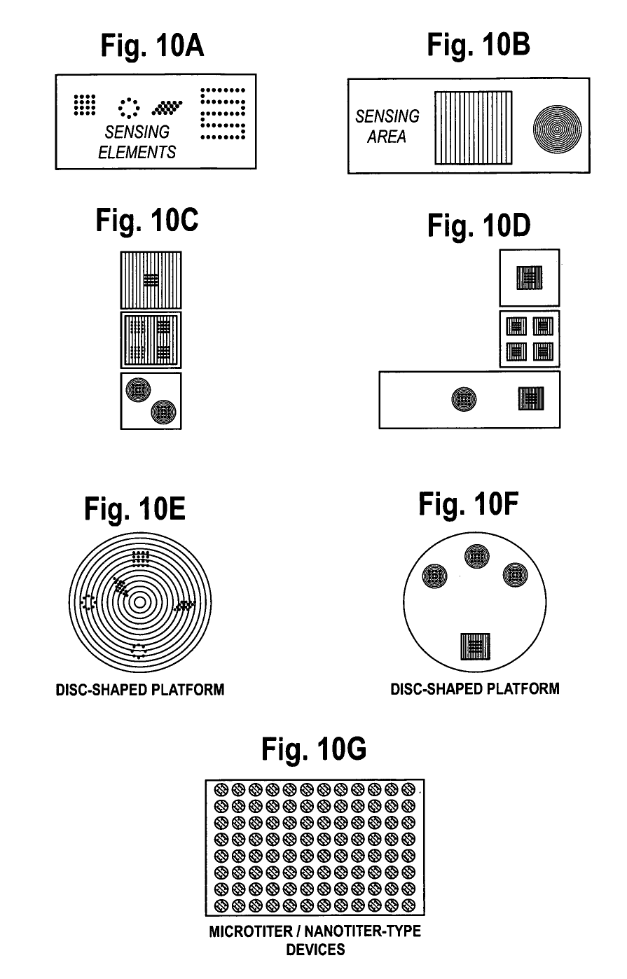

FIG. 10 illustrates alternative forms of a biosensor platform, including: discs, concentric designs, etc., as shown in International Patent Application WO 01/02839. The sensing elements (see FIG. 10a) can be arranged in various ways, for instance rectangular, circular, hexagonal-centric, ellipsoidal, linear or labyrinthine. The sensing area (see FIG. 10b) may be rectangular, round or of any other shape. The grooves may be arranged either equidistant linear or equidistant circular, or may correspond to segments of such structures. The platform (see FIGS. 10c to 10f) can be either rectangular or disc-shaped, or of any other geometry. The platform can comprise one or multiple sensing areas, each sensing area can comprise one or multiple capture elements, and each capture element can comprise one or multiple labeled or unlabelled capture molecules. The platform can also be adapted to microtitre-type plates/devices (see FIG. 10g) in order to perform one or multiple assays in the individual microtitre wells. This can be achieved for all plate types: 96, 384, 1536, or higher numbers of wells, independently of the dimensions of the respective microtitre-plate.

FIG. 11 shows a schematic view of an ER sensor similar to that shown in FIGS. 8 and 9.

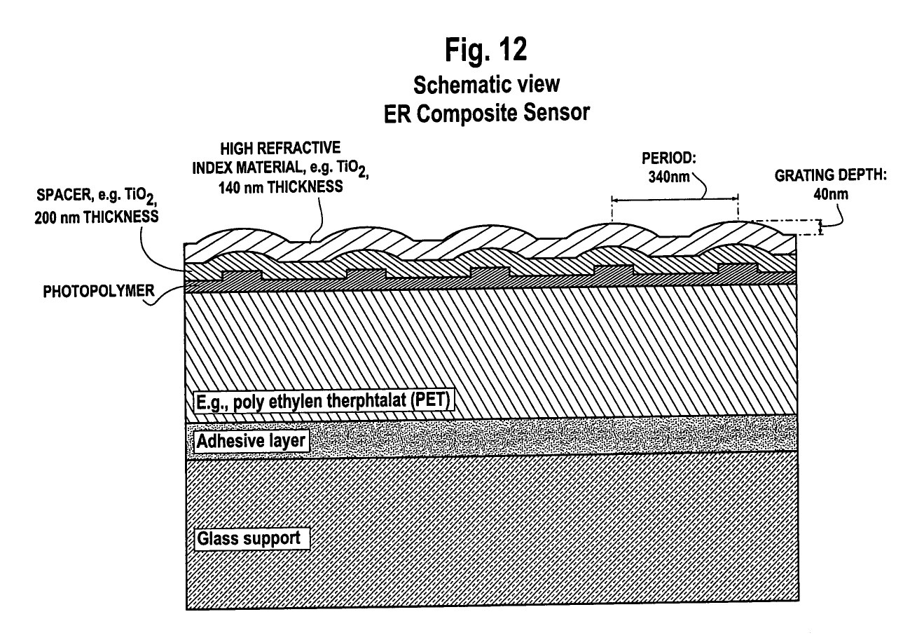

FIG. 12 shows a schematic view of an ER/BIND composite sensor.

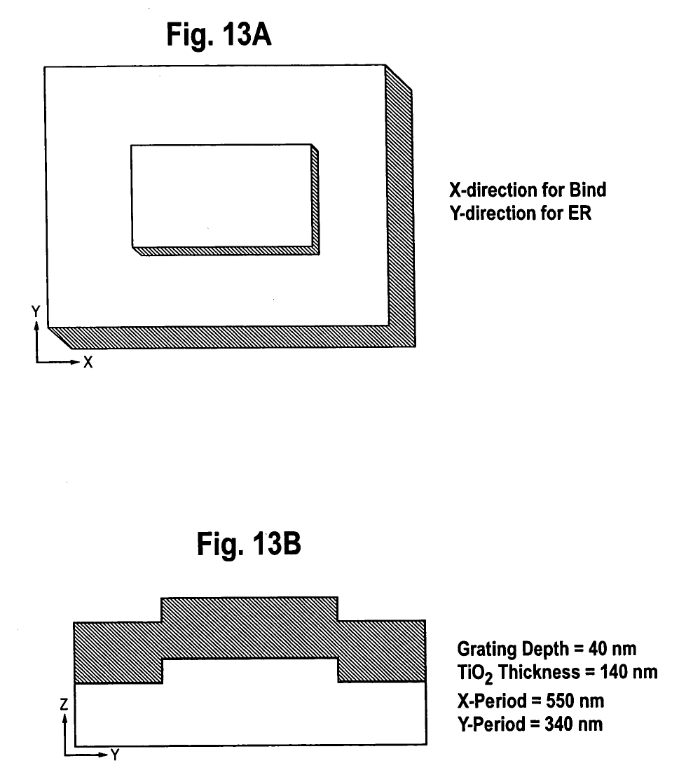

FIGS. 13A and B are two views of a unit cell of an ER/BIND composite sensor as shown in FIG. 12, where the grating depth<thickness of high refractive index layer.

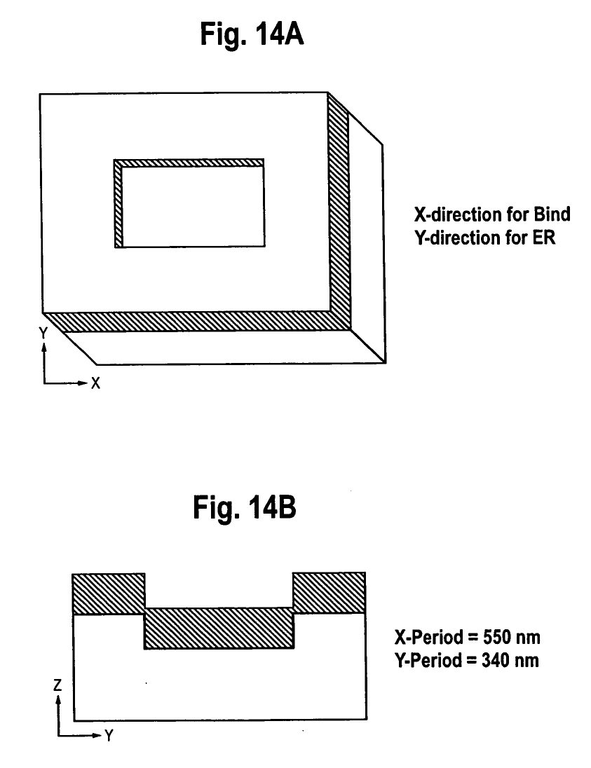

FIGS. 14A and 14B are two views of a unit cell of an ER/BIND composite sensor as shown in FIG. 12, where the grating depth>thickness of high refractive index layer.

From the above discussion, it will be appreciated that we have disclosed a method for assessing the immobilization quality and/or quantity of probes or an array of probes immobilized on a biosensor having a periodic grating structure and a multitude of probe locations on a surface thereof, wherein the immobilization quality and/or quantity of the immobilized probes is assessed individually at each probe location in a spatially resolved manner prior to the binding of an analyte to the probes,

said method comprising the steps of:
(1) obtaining two-dimensional data and/or images from said biosensor by:
   (A) in an Evanescent Resonance mode, exciting of bound luminescence labels and collecting data of the resulting emissions from said biosensor, and
   (B) in a label-free mode, obtaining a two dimensional image of the biosensor surface and peak wavelength value (PWV) data for the portions of the two-dimensional image which comprise images of probe locations of the biosensor, the peak wavelength value comprising the peak wavelength of light reflected from the biosensor due to resonant coupling of light into the biosensor; and
(2) characterizing the immobilization quality and/or quantity of the probes or array of probes immobilized on the biosensor surface from the two-dimensional data and/or images.

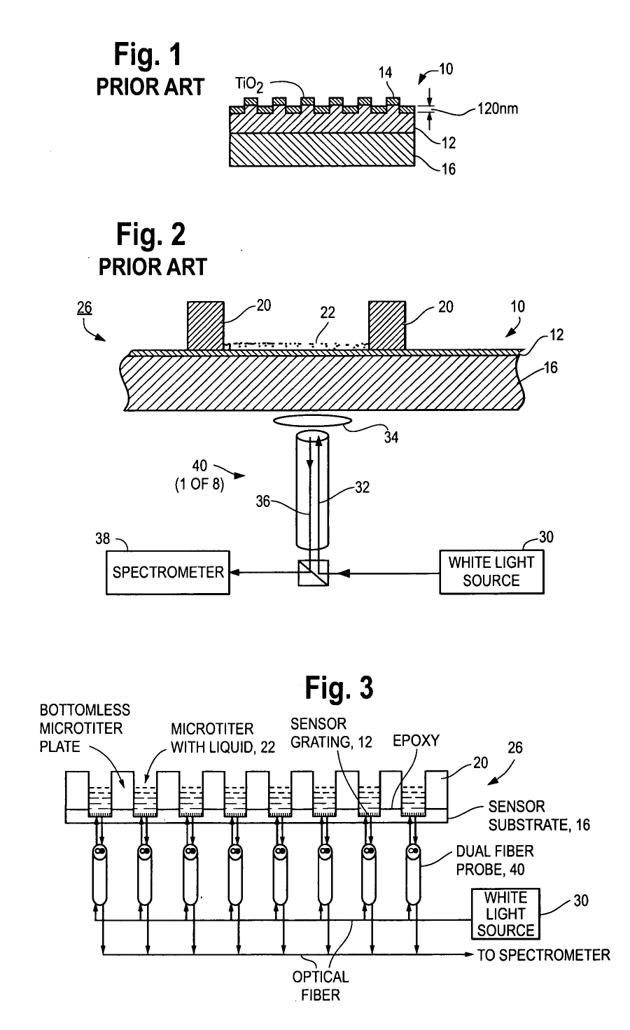

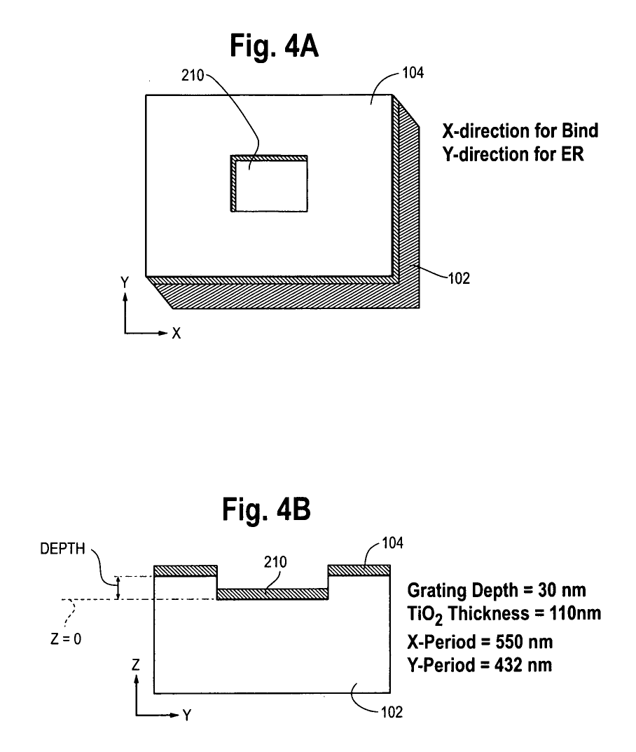

In one embodiment, the biosensor comprises a multitude of sample regions (FIGS. 8, 9A-C), each sample region potentially containing biological material bound to the biosensor, and wherein the array is formed as a surface of a periodic grating structure (FIG. 1-6), and wherein step (1) of the method comprises the steps of:
(1) obtaining a two-dimensional image of the biosensor (FIG. 8);
(2) obtaining peak wavelength value (PWV) data for the portions of the two-dimensional image which comprise images of sample regions of the biosensor (FIG. 9B), the peak wavelength value comprising the peak wavelength of light reflected from the biosensor due to resonant coupling of light into the grating structure; and
(3) obtaining quantitative information as to the amount of binding of the biological material to the sample regions of the array from the peak wavelength value data (e.g., obtained from BIND data, see also Tables 1B, 2).

The probes may be deposited on the biosensor using any convenient and known method, including use of a printer, piezo-array printer or pin printer.

Further, the biosensor may be attached to an internal surface of a liquid containing vessel, such as a bottomless microwell plate, a test tube, a Petri dish and a microfluidic channel.

In another aspect, a method for assessing the immobilization quality and/or quantity of probes or an array of probes immobilized on a biosensor having a periodic grating structure and a multitude of probe locations on a surface thereof, wherein the immobilization quality and/or quantity of the probes is assessed individually at each probe location in a spatially resolved manner prior to the binding of an analyte to the probes, said method comprising the steps of:
(1) measuring peak wavelength value (PWV) data of the probe locations of the biosensor;
(2) obtaining a 2-dimensional image of the probe locations in a spatially resolved manner (PWV images) (FIG. 9B),
(3) obtaining quantitative information of the immobilization quality and/or quantity of probes immobilized on the biosensor from the PWV data (e.g., obtained from BIND data, see also Tables 1B, 2).

In the above method, the method may further comprise the steps of:
1) applying a labelled sample to the multitude of probe locations;
2) obtaining evanescent resonance (ER) measurements of the multitude of probe locations (FIG. 9C); and
3) normalizing the ER measurements with the quantitative information obtained.
   In one embodiment the normalization of the ER measurements is according to normalizing equation (1).

In one embodiment, the PWV data and images are indicative for the amount and morphology of potentially immobilized material on the surface of the biosensor. The method further comprises the step of using the PWV data and images to calibrate data and images obtained after hybridization of a sample to the immobilized material.

In some embodiments of the method of this disclosure, the method may further include the steps of acquiring label free PWV data and images (FIG. 9B) and/or ER measurements (FIG. 9C) at one or more stages in a process of manufacture of the biosensor, including one or more of the following stages: biosensor surface cleaning, biosensor surface modification, immobilization of materials onto the biosensor surface, biosensor wash steps, biosensor drying steps, and hybridization of a sample on the surface of the biosensor.

Additionally, the method may further comprise the step of correcting data and images obtained after hybridization (FIG. 9C) based on the pre-hybridisation PWV images/data (FIG. 9B), thus calibrating/compensating for variations of amount and morphology of immobilized capture material immobilised on the biosensor.

In some embodiments, the biosensor takes the form of a substrate (e.g., polyester or MYLAR sheet) and wherein the surface of the biosensor is coated with a layer of high index of refraction material (e.g., TiO₂) consisting of material having a refractive index n₂ higher than that of the substrate n₁, wherein the depth of the layer is between 10 and 1000 nm, and the resulting periodicity is in the range of 100 to 1000 nm, and the substrate is of planar, cylindrical, conical, spherical, or elliptical geometry.

In some embodiments, a salt image (FIG. 9A) is further obtained and analysed. The salt image resulting from the method of spotting the probes to be immobilised to the support, said method comprising the steps of spotting a salt containing-solution containing the probes to be immobilised to the support, optionally drying said salt containing-solution containing the probes, and obtaining an image of the locations where the probes should have been immobilised, said image being obtained prior to any washing step, so that the absence of salt at a specific location indicates that spotting of the probe to be immobilised at this specific location has not occurred at said specific location.

The substrate of the biosensor (FIGS. 1-7) is made of materials selected from the group consisting of glass, quartz, metal oxides, dielectric materials, inorganic or organic high refractive index materials, silicon, polymers, plastic, PET, PC, PU, COPs, low fluorescence background plastic materials, adhesive layers and combinations thereof.

The biosensor preferably includes an optically transparent layer which is formed from inorganic material selected from the group consisting of a metal oxide such as Ta₂O₅, TiO₂, Nb₂O₅, ZrO₂, ZnO or HfO₂; organic materials selected from the group consisting of polyamide, polyimide, PP, PS, PMMA, polyacryl acids, polyacryl esters, polythioether, or poly(phenylenesulfide); and derivatives thereof. The optically transparent layer can be either the periodic surface grating material layer or the high index of refraction dielectric material deposited on the grating.

In the methods of this disclosure, the immobilized probes or array of probes are labelled with at least one of the following: spacers molecules, energy-donors, energy-acceptors, electron-donors, electron-acceptors, chromophores, luminophores, fluorophores, phosphorescence labels, spectroscopic labels, biological functions, or chemical modifications. In other embodiments, the array of probes are unlabeled.

The methods may further include a step of placing an immobilized material on the biosensor, wherein the immobilized material is selected from the group of materials consisting of molecules having a molecular weight of less than 1000 daltons, molecules with a molecular weight of between 1000 and 10,000 daltons, amino acids, proteins, nucleic acids, lipids, carbohydrates, nucleic acid polymers, viral particles, viral components, cellular components, and extracts of viral or cellular components, polypeptides, antigens, polyclonal antibodies, monoclonal antibodies, single chain antibodies (scFv), F(ab) fragments, F(ab′)2 fragments, Fv fragments, small organic molecules, cells, viruses, bacteria, polymers, peptide solutions, protein solutions, chemical compound library solutions, single-stranded DNA solutions, double stranded DNA solutions, combinations of single and double stranded DNA solutions, RNA solutions, oligonucleotide derivatives and biological samples.

In some embodiments, the array of probes deposited on the biosensor are unlabeled. In this case, evanescent resonance (ER) data/images (FIG. 9C) are obtained from the biosensor and calibrated using the quantitative information obtained from BIND measurements or images obtained from the sensor.

In the methods of this disclosure, the methods may further include a step of obtaining a spectrum for background signals produced by the biosensor and wherein the characterization of the immobilization quality and/or quantity of probes is made after subtraction of the spectrum for background signals produced by the biosensor.

In still another aspect, a method of detecting and/or quantifying an analyte using an biosensor (FIG. 8) comprising an array of immobilised probes on a surface thereof, the biosensor constructed in the form of a periodic grating structure, wherein the presence and/or concentration of said analyte is normalised with respect to the presence and/or concentration of said immobilised probes as described above, wherein said presence and/or concentration of said immobilised probes is assessed at locations of the array prior to the potential binding of the analyte to the surface of the biosensor. The presence and/or concentration of the immobilized probes is assessed using a two dimensional image of the biosensor surface and peak wavelength value (PWV) data for the portions of the two-dimensional image which comprise images of probe locations of the biosensor, the peak wavelength value comprising the peak wavelength of light reflected from the biosensor due to resonant coupling of light into the biosensor The method may further include the step of obtaining a spectrum for background signals produced by the biosensor and wherein the normalization is performed after subtraction of said spectrum for background signals produced by the biosensor.

The method may also further include the steps of:
(1) processing the biosensor to prepare for a hybridisation of a sample,
(2) hybridizing the sample to the biosensor; and
(3) recording a post-hybridisation image of the biosensor, where the resulting image represents the bound sample.

This method may further include a step of recording a post-hybridisation label free image (FIG. 9B) in a label-free mode of the biosensor.

The method may further include a step of correcting the post-hybridisation image based on the pre-hybridisation data obtained, thus compensating for capture material variations on the biosensor.

The samples in this method may be labelled, and such samples may consist of for example samples selected from the group consisting of blood, plasma, serum, nucleic acids, gastrointestinal secretions, homogenates of tissues or tumours, synovial fluid, faeces, saliva, sputum, cyst fluid, amniotic fluid, cerebrospinal fluid, peritoneal fluid, lung lavage fluid, semen, lymphatic fluid, tears, prostatic fluid, biopsies, body fluids and extractions/derivatives thereof.

In another aspect, a non-contact method of qualitative analysis of a microarray chip, comprising the steps of:
(a) providing a microarray chip (FIG. 8) in the form of a multitude of sample regions 802 on a surface of a periodic grating structure (FIGS. 1-7);
(b) depositing of capture elements to the grating structure;
(c) obtaining a two-dimensional image of the microarray chip (FIG. 8, 9A);
(d) obtaining peak wavelength value (PWV) data (FIG. 9B) for the portions of the two-dimensional image which comprise images of sample regions of the microarray chip, the peak wavelength value comprising the peak wavelength of light reflected from the microarray due to resonant coupling of light into the grating structure; and
(e) obtaining qualitative information as to the binding of the capture elements to the sample regions of the microarray from either (1) the two-dimensional image or (2) the peak wavelength value data.
   In this method, the capture elements can be deposited using a piezo-array or pin printer.

The qualitative information obtained in step e) characterizing the binding of the capture elements as a function of the position on the surface of the biosensor. The capture elements can vary, and in one embodiment are selected from the group of materials consisting of a nucleic acid material and a protein.

In yet another aspect of this disclosure, a method of analysis of a microarray chip (FIG. 8) is provided comprising the steps of:
(a) providing a microarray chip in the form of a multitude of sample regions 802 on a surface of a periodic grating structure (FIG. 1-7);
(b) applying a biological material to the sample regions;
(c) obtaining a two-dimensional image of the microarray (FIG. 8, 9A);
(d) obtaining peak wavelength value (PWV) data (FIG. 9B) for the portions of the two-dimensional image which comprise images of sample regions of the microarray, the peak wavelength value comprising the peak wavelength of light reflected from the microarray due to resonant coupling of light into the grating structure;
(e) performing a hybridisation step comprising applying a second sample material to the sample regions;
(f) obtaining a two-dimensional image of the microarray after the hybridisation step (FIG. 9C); and
(g) obtaining peak wavelength value (PWV) data for the portions of the two-dimensional image which comprise images of sample regions of the microarray after the hybridisation step.

In one embodiment of this method the hybridisation step comprises the step of applying a fluorescent probe to the biological material.

The method may further include a step of obtaining evanescent resonance (ER) measurements of the sample regions after the hybridisation step. In particular, the method may include obtaining ER measurements from the microarray chip and normalizing the measurements with reference to quantitative data of the amount of biological material bound to the sample regions obtained from the peak wavelength value (PWV) data obtained in step d). The biological material adhered to a biosensor can take the form of a DNA microarray.

In still another aspect, a method for the determination of the amount of DNA adhered to a biosensor following a hybridisation protocol is disclosed, in which the method comprises the combined use of label-free and label methods, as described herein.

The following are definitions of terms which will be used in the description:
“Platform”, “biosensor” or “support”: a whole transducer/chip containing one or a plurality of sensing areas.
“Peak wavelength value (PWV)”: position and intensity of the resonance generated with incident light incident on the periodical structure under resonance conditions, as measured by a detection system. In other words, measurement of the PWV comprises measurement of the position and intensity of the transmitted beam or of the abnormal high reflection at each location.
“Sensing area”: a whole corrugated area capable of creating an evanescent field by a resonance effect and containing one or a plurality of capture elements.
“Capture element”, “location” or “probe”: an individual sensing spot containing one or a variety of species of capture molecules.
The expressions “location of the array” or “regions of the support” is not to be understood as being limited to a whole spot of deposited/attached material. The smallest size of said “regions of the support” depends on the optical resolution of the used detection system. In other words, the method of the invention can be carried out e.g. (scanning) pixel-wise.
“Orientation” is understood to mean that the electric field vector of the linearly polarized light is parallel or perpendicular to the periodic surface grating of the biosensor.
“Coherent light” is understood to mean that the coherence length of the radiation, i.e. the spatial extent to which the incident beam has a defined phase relation, is large compared to the thickness of the biosensor.

### EQUIVALENTS

The present invention is not to be limited in terms of the particular embodiments described in this application, which are intended as single illustrations of individual aspects of the invention. Many modifications and variations of this invention can be made without departing from its spirit and scope, as will be apparent to those skilled in the art. Functionally equivalent methods and apparatuses within the scope of the invention, in addition to those enumerated herein, will be apparent to those skilled in the art from the foregoing descriptions. Such modifications and variations are intended to fall within the scope of the appended claims. The present invention is to be limited only by the terms of the appended claims along with the full scope of equivalents to which such claims are entitled.

We claim:

1. A method for assessing the immobilization quality and/or quantity of probes or an array of probes immobilized on a biosensor having a periodic grating structure and a multitude of probe locations on a surface thereof, wherein the immobilization quality and/or quantity of the immobilized probes is assessed individually at each probe location in a spatially resolved manner prior to the binding of an analyte to the probes,
said method comprising the steps of:
(1) obtaining two-dimensional data and/or images from said biosensor by:
(A) in an Evanescent Resonance mode, exciting of bound luminescence labels bound to the probes and collecting data of the resulting emissions from said biosensor, and
(B) in a label-free mode, obtaining a two dimensional image of the biosensor surface and peak wavelength value (PWV) data for the portions of the two-dimensional image which comprise images of probe locations of the biosensor, the peak wavelength value comprising the peak wavelength of light reflected from the biosensor due to resonant coupling of light into the biosensor; and
(2) characterizing the immobilization quality and/or quantity of the probes or array of probes immobilized on the biosensor surface from the two-dimensional data and/or images.

2. The method of claim 1, wherein the biosensor comprises a multitude of sample regions, each sample region potentially containing biological material bound to the biosensor, and wherein the array is formed as a surface of a periodic grating structure and wherein step (1) of the method comprises the steps of:
(1) obtaining a two-dimensional image of the biosensor;
(2) obtaining peak wavelength value (PWV) data for the portions of the two-dimensional image which comprise images of sample regions of the biosensor, the peak wavelength value comprising the peak wavelength of light reflected from the biosensor due to resonant coupling of light into the grating structure; and
(3) obtaining quantitative information as to the amount of binding of the biological material to the sample regions of the array from the peak wavelength value data.

3. A method for assessing the immobilization quality and/or quantity of probes or an array of probes immobilized on a biosensor having a periodic grating structure and a multitude of probe locations on a surface thereof, wherein the immobilization quality and/or quantity of the probes is assessed individually at each probe location in a spatially resolved manner prior to the binding of an analyte to the probes,
said method comprising the steps of:
(1) measuring peak wavelength value (PWV) data of the probe locations of the biosensor;
(2) obtaining a 2-dimensional image of the probe locations in a spatially resolved manner (PWV Images)
(3) obtaining quantitative information of the immobilization quality and/or quantity of probes immobilized on the biosensor from the PWV data.

4. The method of claim 2, wherein the method further comprises the steps of:
applying a labelled sample to the multitude of probe locations;
obtaining evanescent resonance (ER) measurements of the multitude of probe locations; and
normalizing the ER measurements with the quantitative information obtained.

5. The method of claim 4, wherein the normalization of the ER measurements is according to normalizing equation (1).

6. The method of claim 3, wherein the method further comprises the steps of:
applying a labelled sample to the multitude of probe locations;
obtaining evanescent resonance (ER) measurements of the multitude of probe locations; and
normalizing the ER measurements with the quantitative information obtained.

7. The method of claim 6, wherein the normalization of the ER measurements is according to normalizing equation (1).

8. The method of claim 3, wherein the PWV data and images are indicative for the amount and morphology of potentially immobilized material on the surface of the biosensor, and wherein the method further comprises the step of using the PWV data and images to calibrate data and images obtained after hybridization of a sample to the immobilized material.

9. The method of claim 1, further comprising the step of acquiring label free PWV data and images and/or ER measurements at one or more stages in a process of manufacture of the biosensor, including one or more of the following stages: biosensor surface cleaning, biosensor surface modification, immobilization of materials onto the biosensor surface, biosensor wash steps, biosensor drying steps, and hybridization of a sample on the surface of the biosensor.

10. The method of claim 8, further comprising the step of correcting data and images obtained after hybridization based on the pre-hybridisation PWV images/data, thus calibrating/compensating for variations of amount and morphology of immobilized capture material immobilised on the biosensor.

11. The method of claim 2, wherein the biosensor further comprises a substrate and wherein the surface of the biosensor is coated with a layer of high index of refraction material consisting of material having a refractive index n₂ higher than that of the substrate n₁, wherein the depth of the layer is between 10 and 1000 nm, and the resulting periodicity is in the range of 100 to 1000 nm, and the substrate is of planar, cylindrical, conical, spherical, or elliptical geometry.

12. The method of claim 1, wherein a salt image is further obtained and analysed, said salt image resulting from the method of spotting the probes to be immobilised to the support, said method comprising the steps of spotting a salt containing-solution containing the probes to be immobilised to the support, optionally drying said salt containing-solution containing the probes, and obtaining an image of the locations where the probes should have been immobilised, said image being obtained prior to any washing step, so that the absence of salt at a specific location indicates that spotting of the probe to be immobilised at this specific location has not occurred at said specific location.

13. The method of claim 1, wherein the substrate of the biosensor is made of materials selected from the group consisting of glass, quartz, metal oxides, dielectric materials, inorganic or organic high refractive index materials, silicon, polymers, plastic, PET, PC, PU, COPs, low fluorescence background plastic materials, adhesive layers and combinations thereof.

14. The method of claim 1, wherein the biosensor includes an optically transparent layer is formed from inorganic material selected from the group consisting of a metal oxide such as Ta₂O₅, TiO₂, Nb₂O₅, ZrO₂, ZnO or HfO₂; organic materials selected from the group consisting of polyamide, polyimide, PP, PS, PMMA, polyacryl acids, polyacryl esters, polythioether, or poly(phenylenesulfide); and derivatives thereof.

15. The method of claim 1, wherein the immobilized probes or array of proves are labelled with at least one of the following: spacers molecules, energy-donors, energy-acceptors, electron-donors, electron-acceptors, chromophores, luminophores, fluorophores, phosphorescence labels, spectroscopic labels, biological functions, or chemical modifications.

16. The method of claim 1, further comprising the step of placing an immobilized material on the biosensor, wherein the immobilized material is selected from the group of materials consisting of molecules having a molecular weight of less than 1000 daltons, molecules with a molecular weight of between 1000 and 10,000 daltons, amino acids, proteins, nucleic acids, lipids, carbohydrates, nucleic acid polymers, viral particles, viral components, cellular components, and extracts of viral or cellular components, polypeptides, antigens, polyclonal antibodies, monoclonal antibodies, single chain antibodies (scFv), F(ab) fragments, F(ab′)2 fragments, Fv fragments, small organic molecules, cells, viruses, bacteria, polymers, peptide solutions, protein solutions, chemical compound library solutions, single-stranded DNA solutions, double stranded DNA solutions, combinations of single and double stranded DNA solutions, RNA solutions, oligonucleotide derivatives and biological samples.

17. The method of claim 1, wherein the probes or array of probes are unlabelled.

18. The method of claim 17, wherein evanescent resonance (ER) data/images are calibrated using the quantitative information obtained in step 3 of claim 1.

19. The method of claim 17, wherein label-free/PWV data and/or images are calibrated using the quantitative information obtained in step 3 of claim 1.

20. The method of claim 1, further comprising the step of obtaining a spectrum for background signals produced by the biosensor and wherein the characterization of the immobilization quality and/or quantity is made after subtraction of said spectrum for background signals produced by the biosensor.

21. A method of detecting and/or quantifying an analyte using an biosensor comprising an array of immobilised probes on a surface thereof, the biosensor constructed in the form of a periodic grating structure, wherein the presence and/or concentration of said analyte is normalised with respect to the presence and/or concentration of said immobilised probes, wherein said presence and/or concentration of said immobilised probes is assessed at locations of the array prior to the potential binding of the analyte to the surface of the biosensor.

22. The method of claim 21, wherein the presence and/or concentration of the immobilized probes is assessed using a two dimensional image of the biosensor surface and peak wavelength value (PWV) data for the portions of the two-dimensional image which comprise images of probe locations of the biosensor, the peak wavelength value comprising the peak wavelength of light reflected from the biosensor due to resonant coupling of light into the biosensor

23. The method of claim 21, further comprising the step of obtaining a spectrum for background signals produced by the biosensor and wherein the normalization is performed after subtraction of said spectrum for background signals produced by the biosensor.

24. The method of claim 21, further comprising the steps of:
(1) processing the biosensor to prepare for a hybridisation of a sample,
(2) hybridizing the sample to the biosensor; and
(3) recording a post-hybridisation image of the biosensor, where the resulting image represents the bound sample.

25. The method of claim 24, further comprising the step of recording a post-hybridisation label free image in a label-free mode of the biosensor.

26. The method of claim 24, further comprising performing background subtraction methods to compensate for background levels of signals produced by the biosensor.

27. The method of claim 25, further comprising the step of correcting the post-hybridisation image based on the pre-hybridisation data obtained, thus compensating for capture material variations on the biosensor.

28. The method of claim 4, wherein the labelled samples comprise samples selected from the group consisting of blood, plasma, serum, nucleic acids, gastrointestinal secretions, homogenates of tissues or tumours, synovial fluid, faeces, saliva, sputum, cyst fluid, amniotic fluid, cerebrospinal fluid, peritoneal fluid, lung lavage fluid, semen, lymphatic fluid, tears, prostatic fluid, biopsies, body fluids and extractions/derivatives thereof.

29. The method of claim 1, wherein the probes are deposited on the biosensor with a printer.

30. The method of claim 1, wherein the biosensor is attached to an internal surface of a liquid containing vessel.

31. The method of claim 30, wherein the liquid containing vessel is selected from the group consisting of a microtitre plate, a test tube, a Petri dish and a microfluidic channel.

32. A non-contact method of qualitative analysis of a microarray chip, comprising the steps of:
(a) providing a microarray chip in the form of a multitude of sample regions on a surface of a periodic grating structure;
(b) depositing of capture elements to the grating structure;
(c) obtaining a two-dimensional image of the microarray chip;
(d) obtaining peak wavelength value (PWV) data for the portions of the two-dimensional image which comprise images of sample regions of the microarray chip, the peak wavelength value comprising the peak wavelength of light reflected from the microarray due to resonant coupling of light into the grating structure; and
(e) obtaining qualitative information as to the binding of the capture elements to the sample regions of the microarray from either (1) the two-dimensional image or (2) the peak wavelength value data.

33. The method of claim 32, wherein the capture elements are deposited using a piezo-array printer.

34. The method of claim 32, wherein the material is applied/deposited using a pin printer.

35. The method of claim 32, wherein the qualitative information obtained in step e) comprises characterizing the binding of the capture elements as a function of the position on the surface of the biosensor.

36. The method of claim 32, wherein the capture elements are selected from the group of materials consisting of a nucleic acid material and a protein.

37. A method of analysis of a microarray chip comprising the steps of:
(a) providing a microarray chip in the form of a multitude of sample regions on a surface of a periodic grating structure;
(b) applying a biological material to the sample regions;
(c) obtaining a two-dimensional image of the microarray;
(d) obtaining peak wavelength value (PWV) data for the portions of the two-dimensional image which comprise images of sample regions of the microarray, the peak wavelength value comprising the peak wavelength of light reflected from the microarray due to resonant coupling of light into the grating structure;
(e) performing a hybridisation step comprising applying a second sample material to the sample regions;
(f) obtaining a two-dimensional image of the microarray after the hybridisation step; and
(g) obtaining peak wavelength value (PWV) data for the portions of the two-dimensional image which comprise images of sample regions of the microarray after the hybridisation step.

38. The method of claim 37, wherein the hybridisation step comprises the step of applying a fluorescent probe to the biological material.

39. The method of claim 37, further comprising the step of obtaining evanescent resonance (ER) measurements of the sample regions after the hybridisation step.

40. The method of claim 37, further comprising the step of obtaining ER measurements from the microarray chip and normalizing the measurements with reference to quantitative data of the amount of biological material bound to the sample regions obtained from the peak wavelength value (PWV) data obtained in step d).

41. The method of claim 37, where the biological material adhered to a biosensor comprises a DNA microarray.

42. A method for the determination of the amount of DNA adhered to a biosensor following a hybridisation protocol comprising the combined use of label-free and label methods.
